(19) United States
(12) Patent Application Publication
(10) Pub. No.: US 2025/0102389 A1
(43) Pub. Date: Mar. 27, 2025

(54) PUMP INLET PRESSURE STABILIZER FOR MEASURING STORAGE TANK LIQUID LEVEL USING PRESSURE MEASUREMENT

(71) Applicant: ChampionX LLC, Sugar Land, TX (US)

(72) Inventors: Jose Manuel MACIAS, Pearland, TX (US); Miguel BALZAN, Sugar Land, TX (US); Ivan Ruiz VELARDE, Queretaro (MX)

(73) Assignee: ChampionX LLC, Sugar Land, TX (US)

(21) Appl. No.: 18/731,198

(22) Filed: May 31, 2024

Related U.S. Application Data
(60) Provisional application No. 63/585,328, filed on Sep. 26, 2023.

(51) Int. Cl. G01L 19/06; G01F 23/18

(52) U.S. Cl. CPC G01L 19/0609; G01F 23/18

(57) ABSTRACT

A fluid system is disclosed which includes a storage tank formed to define a storage reservoir configured to store a supply of a fluid, a pump system having a pipe coupled to the storage tank and a pump in fluid communication with the storage reservoir of the tank through the pipe, a pressure sensor, and a pump inlet pressure stabilizer. Methods of using the fluid system are also provided herein.

### CROSS-REFERENCE TO RELATED APPLICATIONS

This application claims priority to and the benefit of U.S. Provisional Patent Application No. 63/585,328, filed 26 Sep. 2023, the disclosure of which is now expressly incorporated herein by reference.

### TECHNICAL FIELD

The present disclosure generally relates to fluid systems. More particularly, the disclosure relates to fluid systems with storage tanks.

### BACKGROUND

Fluid systems may include storage tanks and a pump system for pumping liquid stored in the storage tanks. Measurement of the liquid level in these storage tanks may be difficult due to the pressure pulsations or spikes by the pump system.

The inlet valves of the pump may be quick closing valves that cause rapid velocity changes and pressure spikes, often referred to as water hammer, when these valves close quickly against a flowing liquid. These pressure spikes caused by the pump strokes may make it difficult to measure the tank level by pressure measurements.

### BRIEF SUMMARY

The present disclosure provides systems and methods for measuring tank levels in a storage tank. In some embodiments, the disclosure provides a fluid system comprising a storage tank formed to define a storage reservoir configured to store a supply of a fluid. The system also comprises a pump system, which comprises a pipe coupled to the storage tank and a pump in fluid communication with the storage reservoir of the storage tank through the pipe, wherein the pump selectively provides a flow of the fluid from the storage reservoir of the storage tank through the pipe. The system also comprises a pressure sensor configured to measure a hydrostatic pressure in the storage reservoir to monitor a tank level of the fluid in the storage reservoir and a pump inlet pressure stabilizer coupled to the pipe and the pressure sensor to place the pressure sensor in fluid communication with the storage reservoir of the storage tank. The pump inlet pressure stabilizer is configured to reduce a magnitude of pressure spikes from the pump experienced by the pressure sensor to allow the pressure sensor to directly measure the hydrostatic pressure to determine the tank level of the fluid in the storage reservoir while the fluid flows from the storage reservoir.

The pump inlet pressure stabilizer defines a pressure-sensor fluid passageway in fluid communication with the pressure sensor. The pressure-sensor fluid passageway has a first section that extends axially relative to an axis and a second section that extends from the first section at an angle relative to the first section. The first section of the pressure-sensor fluid passageway has an inlet opening located near a center of the flow of the fluid from the storage tank to allow the pressure sensor to directly measure the hydrostatic pressure while the fluid flows from the storage reservoir.

In some embodiments, the pump inlet pressure stabilizer comprises a pressure stabilizer tube having an interior tube section located in an interior region defined by the pipe that is in fluid communication with the storage reservoir and an exterior tube section that extends from the interior tube section through the pipe away from the interior region of the pipe at an angle relative to the interior tube section. The pressure sensor is coupled to the exterior tube section of the pressure stabilizer tube. The interior tube section of the pressure stabilizer tube has an opening located near a center of the flow of the fluid from the storage tank to allow the pressure sensor to directly measure the hydrostatic pressure while the pump provides the flow of the fluid from the storage reservoir.

In some embodiments, the pump inlet pressure stabilizer includes a pressure stabilizer body. The pressure sensor is coupled to the pressure stabilizer body. The pressure stabilizer body is shaped to define the pressure-sensor fluid passageway and a main fluid passageway. The main fluid passageway extends axially through the pressure stabilizer body. The first section of the pressure-sensor fluid passageway is spaced apart radially from the main fluid passageway.

The present disclosure also provides a pump inlet pressure stabilizer adapted for use with a storage tank. The storage tank may have a storage reservoir configured to store a supply of a fluid. The pump inlet pressure stabilizer comprises a pressure stabilizer body. The pressure stabilizer body is coupled to a pipe that is in fluid communication with the storage reservoir of the storage tank and a pressure sensor to place the pressure sensor in fluid communication with the storage reservoir of the storage tank. The pressure stabilizer body is formed to define a pressure-sensor fluid passageway in fluid communication with the pressure sensor. The pressure-sensor fluid passageway has a first section that extends axially relative to an axis and a second section that extends from the first section at an angle relative to the first section, and the first section of the pressure-sensor fluid passageway has an inlet opening located near a center of the flow of the fluid from the storage tank to reduce a magnitude of pressure spikes experienced by the pressure sensor as fluid flows from the storage reservoir to allow the pressure sensor to directly measure the hydrostatic pressure to determine a tank level of the fluid in the storage reservoir while the fluid flows from the storage reservoir.

The present disclosure also provides a method comprising providing a storage tank formed to define a storage reservoir configured to store a supply of a fluid, providing a pipe coupled to the storage tank that defines an interior region in fluid communication with the storage reservoir of the storage tank, providing a pressure sensor configured to measure hydrostatic pressure in the storage reservoir of the storage tank, and providing a pump inlet pressure stabilizer coupled to the pipe and the pressure sensor to place the pressure sensor in fluid communication with the storage reservoir. The method also includes conducting a flow of the fluid from the storage tank and measuring the hydrostatic pressure in the storage reservoir of the storage tank using the pressure sensor while conducting the flow of the fluid from the storage tank to monitor a tank level of the fluid in the storage reservoir.

In some embodiments, the pump inlet pressure stabilizer defines a pressure-sensor fluid passageway having a first section that extends axially relative to an axis and a second section that extends from the first section at an angle relative to the first section. The first section of the pressure-sensor fluid passageway has an inlet opening located near a center of the flow of the fluid from the storage tank.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIG. 1 is a diagrammatic view of a fluid system that includes a storage tank that defines a storage reservoir for storing a fluid supply, a pump system coupled to the storage tank configured to selectively provide a flow of the fluid from the storage reservoir through a pipe, and a pump inlet pressure stabilizer coupled to the pipe upstream of the pump to be in fluid communication with the storage reservoir of the storage tank and configured to reduce the pressure spikes from the pump to allow a pressure sensor to directly measure the hydrostatic pressure in the storage reservoir of the storage tank to monitor a tank level of the fluid in the storage reservoir while the pump provides the flow of the fluid from the storage reservoir;

FIG. 2 is a perspective view of the pump inlet pressure stabilizer included in the system of FIG. 1 showing the pump inlet pressure stabilizer is coupled to a connecting pipe section of the pipe, and further showing the pump inlet pressure stabilizer includes a pressure stabilizer tube that extends from a first end located in an interior region of the connecting pipe section to a second end located outside of the interior region of the pipe and coupled to the pressure sensor so as to place the pressure sensor in fluid communication with the storage reservoir of the storage tank to allow the pressure sensor to measure the hydrostatic pressure in the storage reservoir;

FIG. 3 is a perspective view of the pump inlet pressure stabilizer of FIG. 2 with a portion of the connecting pipe section broken away to show the pressure stabilizer tube includes an interior tube section located in the interior region of the pipe and an exterior tube section that extends from the interior tube section through the connecting pipe section outside the interior region of the pipe;

FIG. 4 is a perspective view of the pump inlet pressure stabilizer included in the system of FIG. 1 showing the interior tube section of the pressure stabilizer tube includes an interior straight member that extends linearly between a first end coupled to a first interior elbow member included in the interior tube section and a second end coupled to a second interior elbow member included in the interior tube section, and further showing the exterior tube section of the pressure stabilizer tube includes an exterior straight member that extends linearly between a first end coupled to the second interior elbow member and a second end coupled to an exterior elbow member included in the exterior tube section;

FIG. 5 is a side view of the pump inlet pressure stabilizer of FIG. 2 showing the pump inlet pressure stabilizer further includes a valve coupled to the pressure stabilizer tube to change between an open position and a closed position as shown in FIG. 6 to control isolation of the pressure sensor;

FIG. 6 is a view similar to FIG. 5 showing the valve included in the pump inlet pressure stabilizer has been changed to the closed position;

FIG. 7 is a detailed view of the fluid system of FIG. 1;

FIG. 8 is a cross-section view of the fluid system of FIG. 7 taken along line 8-8;

FIG. 9 is a cross-section view of the fluid system of FIG. 7 taken along line 9-9;

FIG. 10 is a plot showing the tank level of the fluid in the storage reservoir of the storage tank over time measured by the pressure sensor coupled to the pressure stabilizer tube compared to the measurements of a control pressure sensor at the pump inlet piping;

FIG. 11 is a plot showing the tank level of the fluid in the storage reservoir of the storage tank over time and showing the effect of the flow rate change of the pump on the measurements from the pump inlet pressure stabilizer compared to the control pressure sensor;

FIG. 12 is a plot showing the tank level of the fluid in the storage reservoir of the storage tank over time measured by the pressure sensor coupled to the pressure stabilizer tube;

FIG. 13 is a perspective view of another embodiment of a system showing the system includes a pump inlet pressure stabilizer coupled to a pipe, the pump inlet pressure stabilizer including a pressure stabilizer tube that extends from a first end located in an interior region of the pipe to a second end located outside of the interior region of the pipe and a pressure sensor coupled to the second end of the pressure stabilizer tube so as to measure the hydrostatic pressure in the storage reservoir, and further showing the second end of the pressure stabilizer tube does not include the elbow member at the one end of the pressure stabilizer tube;

FIG. 14 is a perspective view of the pressure stabilizer tube included in the pump inlet pressure stabilizer of FIG. 13 showing the pressure stabilizer tube includes an interior tube section located in the interior region of the connecting pipe section and an exterior tube section that extends from the interior tube section through a connecting pipe section of the pipe outside the interior region of the pipe;

FIG. 15 is a perspective view of another embodiment of a system showing the system includes a pump inlet pressure stabilizer coupled to a pipe, the pump inlet pressure stabilizer including a pressure stabilizer tube that extends from a first end located in an interior region of the pipe to a second end located outside of the interior region of the pipe, and a pressure sensor coupled to the second end of the pressure stabilizer tube so as to measure the hydrostatic pressure in the storage reservoir, and further showing an interior u-member included in a interior tube section of the presser stabilizer tube instead of the first interior elbow member in the embodiment of FIGS. 1-9;

FIG. 16 is a perspective view of another embodiment of a system showing the system includes a pump inlet pressure stabilizer coupled to a pipe and the pipe includes a connecting pipe section with a linear or straight shape compared to the elbow shape of the connecting pipe section in FIG. 2;

FIG. 17 is a perspective view of another embodiment of a system showing the system includes a pump inlet pressure stabilizer coupled to a pipe and the pipe includes a connecting pipe section with a linear or straight shape;

FIG. 18 is a perspective view of another embodiment of a fluid system that includes a storage tank, a pump system, and a pump inlet pressure stabilizer coupled to the pipe upstream of the pump to be in fluid communication with the storage reservoir of the storage tank and configured to reduce the pressure spikes from the pump to allow a pressure sensor to directly measure the hydrostatic pressure in the storage reservoir of the storage tank to monitor a tank level of the fluid in the storage reservoir while the pump provides the flow of the fluid from the storage reservoir;

FIG. 19 is a perspective view of the pump inlet pressure stabilizer included in the system of FIG. 18 showing the pump inlet pressure stabilizer defines a main fluid passageway in fluid communication with the pipe and a pressure-sensor fluid passageway in fluid communication with the pipe and the pressure sensor so that the pressure sensor is able to directly measure the hydrostatic pressure while the fluid flows from the storage reservoir;

FIG. 20 is a perspective view of the pump inlet pressure stabilizer of FIG. 19 showing the pressure-sensor fluid passageway has a first section that extends axially partway into a pressure stabilizer body of the pump inlet pressure stabilizer relative to an axis and a second section that extends from the first section at an angle relative to the first section, and further showing the first section of the pressure-sensor fluid passageway has an inlet opening located near a center of the flow of the fluid from the storage tank to allow the pressure sensor to directly measure the hydrostatic pressure while the fluid flows from the storage reservoir.

FIG. 21 is a cross-section view of the fluid system of FIG. 20 taken along line 21-21 showing the pressure stabilizer body includes a main section and a connecting section that extends from the main section, and further showing the main fluid passageway extends axially through the main section and a connecting section from one end to the other end of the pressure stabilizer body and the pressure-sensor fluid passageway is offset from the main fluid passageway;

FIG. 22 is a cross-section view similar to FIG. 21 showing the pump inlet pressure stabilizer may further include an extension member coupled to the pressure stabilizer body that extends from the connecting section of the pressure stabilizer body away from the main section and an elbow member coupled to the other end of the extension member, and further showing the extension member defines a portion of the pressure-sensor fluid passageway and the elbow member defines the inlet opening of the pressure-sensor fluid passageway;

FIG. 23 is a perspective view of the pump inlet pressure stabilizer of FIG. 19;

FIG. 24 is a front view of the pump inlet pressure stabilizer of FIG. 23;

FIG. 25 is a top view of the pump inlet pressure stabilizer of FIG. 23; and

FIG. 26 is a rear view of the pump inlet pressure stabilizer of FIG. 23.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not strictly limited to those illustrated in the drawings or described below.

Further, examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

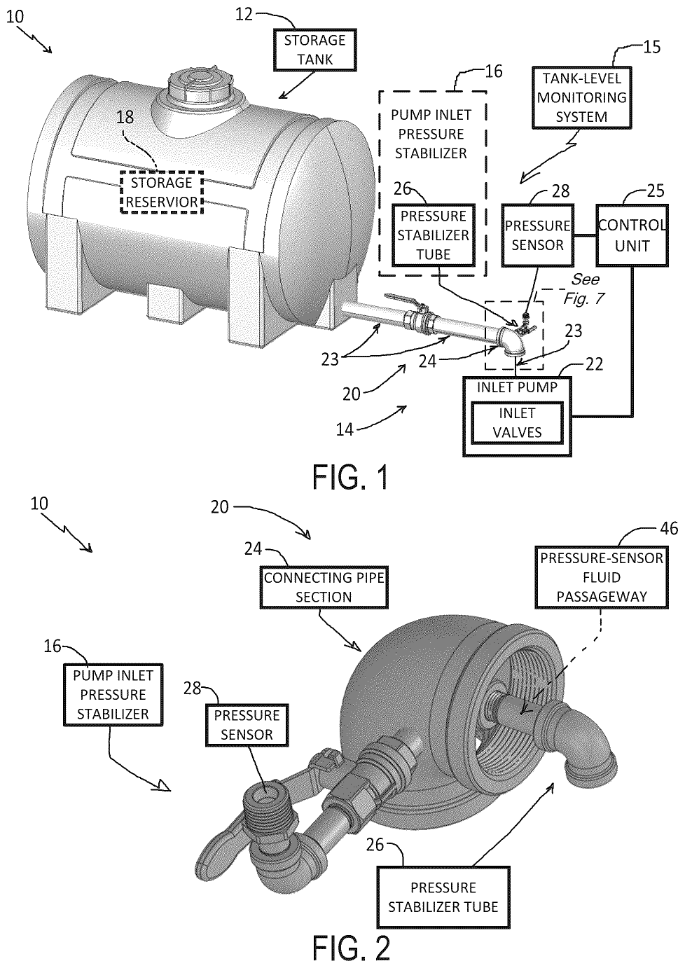

An illustrative fluid system 10 is shown in FIG. 1. The fluid system 10 includes a storage tank 12, a pump system 14, and a pump inlet pressure stabilizer 16 as shown in FIGS. 1-3. The storage tank 12 is formed to define a storage reservoir 18 configured to store a supply or an amount of a fluid. The pump system 14 is coupled to the storage tank 12 so as to selectively provide a flow of the fluid from the storage reservoir 18 of the storage tank 12. The pump inlet pressure stabilizer 16 is coupled to a pipe 20 of the pump system 14 upstream of the pump 22 and a pressure sensor 28 included in the system 10. The pump inlet pressure stabilizer 16 is coupled to the pipe 20 and the pressure sensor 28 to place the pressure sensor 28 in fluid communication with the storage reservoir 18 of the storage tank 12.

The pump inlet pressure stabilizer 16 is configured to allow direct measurement of the hydrostatic pressure in the storage reservoir 18 of the storage tank 12 while the fluid flows from the storage reservoir 18. The pump inlet pressure stabilizer 16 allows for direct measurement of the hydrostatic pressure in the storage reservoir 18 by reducing pressure pulsations or spikes in the pipe 20.

The pump inlet pressure stabilizer 16 is configured to reduce a magnitude of pressure spikes from the pump 22 experienced by the pressure sensor 28 to allow the pressure sensor 28 to directly measure the hydrostatic pressure to determine a tank level of the fluid in the storage reservoir 18 while the fluid flows from the storage reservoir 18. The pump inlet pressure stabilizer 16 reduces the magnitude of the pressure spikes by isolating the hydrostatic pressure from the dynamic pressure. The variations in the dynamic pressure are not captured by the pump inlet pressure stabilizer 16. This way, the sensor 28 only measures the hydrostatic pressure, which is directly related to the fluid level in the tank 12 so that the tank level of the fluid in the storage reservoir 18 of the storage tank 12 may be monitored while the fluid flows from the storage reservoir 18.

Measurement of liquid levels in storage tanks 12, specifically vented storage tanks, may be difficult due to the pressure pulsations or spikes by the pump system 14. In some embodiments, the inlet valves of the pump 22 may be quick closing valves. When these valves close quickly against a flowing liquid, it causes rapid velocity changes and pressure spikes.

These pressure spikes caused by the pump strokes may make it difficult to measure the tank level by pressure measurements. In other embodiments, the storage tank 12 may be modified to allow for tank level measurements. Typically, tank level may be measured with a submersible pressure sensor, a pressure sensor in the port in the tank, or an ultrasonic measurement. In all of these cases, the tank needs to be modified with ports for the sensors.

In other embodiments, the tank may be retrofitted with a separate column and PLC controllers may be used to measure the tank level in the separate column. Multiple valves and automation may also be added to measure the liquid level in the separate column. As such, the additional column introduces additional cost and modifications.

The pump inlet pressure stabilizer 16 is configured to be coupled directly to the piping 20 of the pump system 14 to allow for direct pressure measurement at or near a center of the flow from the storage reservoir 18 of the storage tank 12. The pump inlet pressure stabilizer 16 eliminates the velocity component of the pressure which causes the pressure spikes in the pipe 20. This allows for a simple pressure sensor 28 without the use of any additional automation or modification to the storage tank 12.

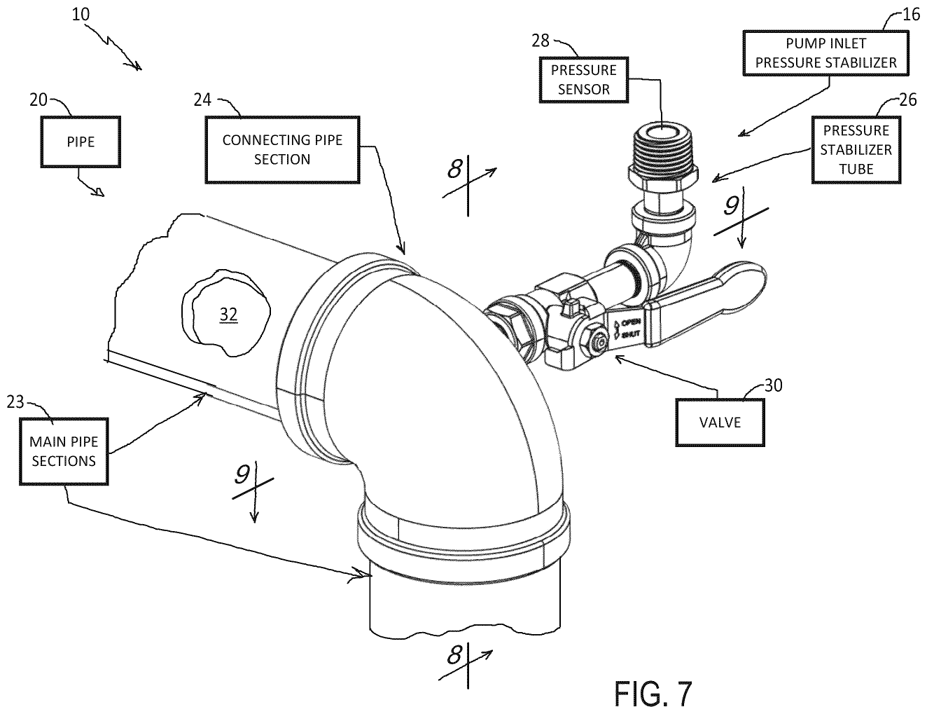

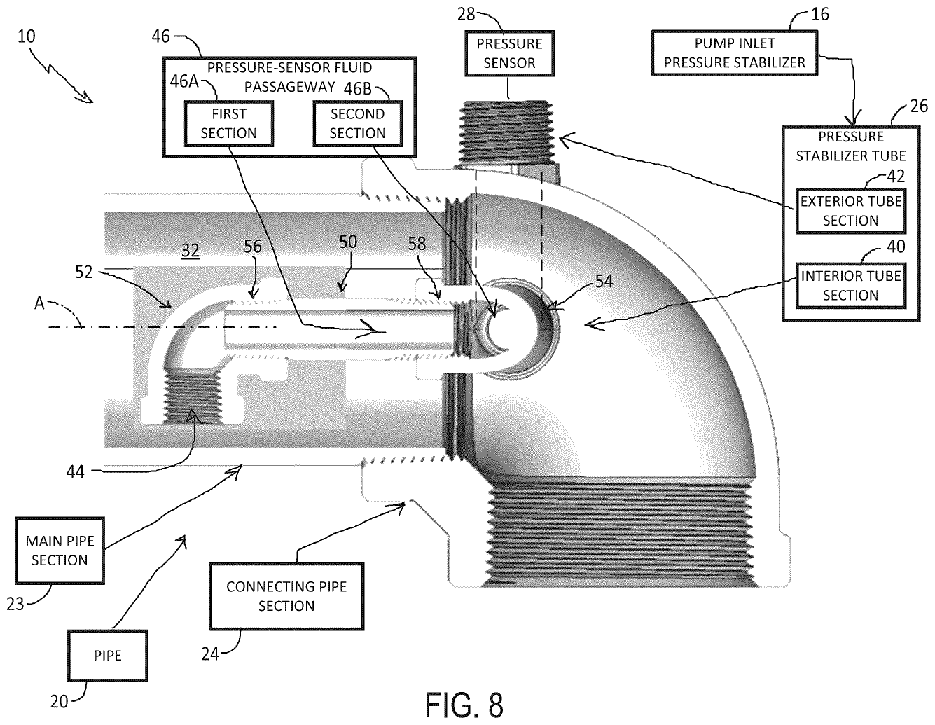

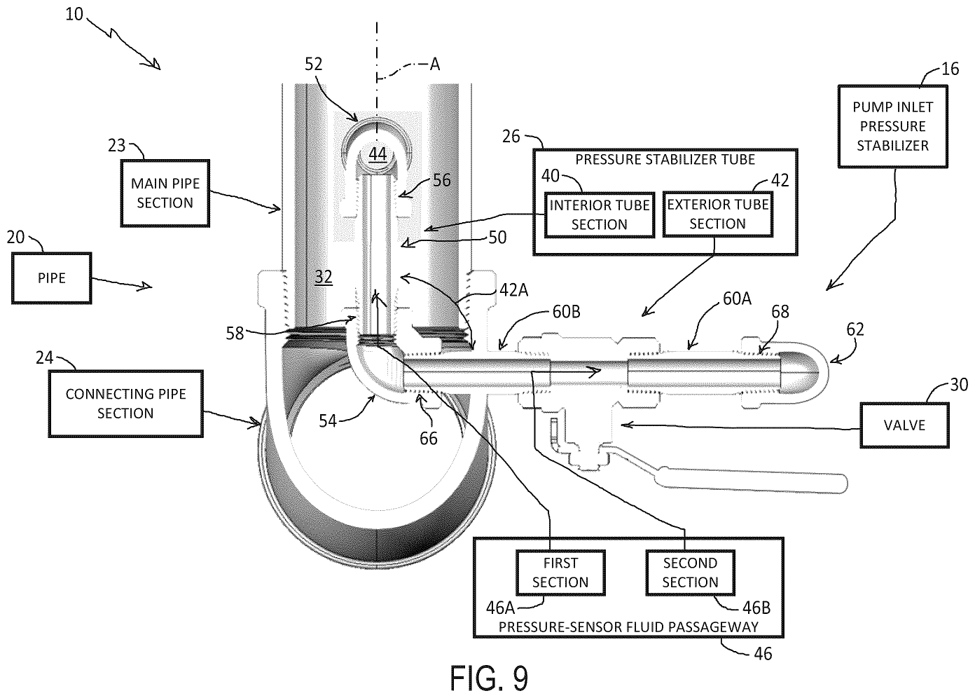

The pump inlet pressure stabilizer 16 includes a pressure stabilizer tube 26 as shown in FIGS. 1-9. The pressure stabilizer tube 26, sometimes also referred to as a pressure stabilizer body 26, defines a pressure-sensor fluid passageway 46 that is in fluid communication with the pressure sensor 28 included in the system 10. The pressure-sensor fluid passageway 46 has a first section 46A that extends axially relative to an axis A and a second section 46B that extends from the first section 46A at an angle 43A relative to the first section 46A as shown in FIGS. 2-9.

The first section 46A of the pressure-sensor fluid passageway 46 defined by the pressure stabilizer tube 26 has an inlet opening 44 located near a center of the flow of the fluid from the storage tank 12 as shown in FIGS. 2-9. The inlet opening 44 is located at or near the center of the flow of the fluid to allow the pressure sensor 28 to directly measure the hydrostatic pressure while the fluid flows from the storage reservoir 18 of the storage tank 12.

In an illustrative embodiment, the pressure stabilizer tube 26 has an interior tube section 40 located in an interior region 32 of the pipe 20 and an exterior tube section 42 that extends from the interior tube section 40 through the pipe 20 away from the interior region 32 of the pipe 20 as shown in FIGS. 2-9. The interior region 32 of the pipe 20, also sometimes referred to as the main fluid passageway 32, is in fluid communication with the storage reservoir 18 of the storage tank 12.

The interior tube section 40 of the pressure stabilizer tube 26 defines the first section 46A of the pressure-sensor fluid passageway 46 and the exterior tube section 42 of the pressure stabilizer tube 26 defines the second section 46B of the pressure-sensor fluid passageway 46 as shown in FIGS. 2-9. The interior tube section 40 of the pressure stabilizer tube 26 defines the opening 44 located near the center of the flow of the fluid from the storage tank 12 as shown in FIGS. 2-9. The exterior tube section 42 extends from the interior tube section 40 at the angle 43A relative to the interior tube section 40 as shown in FIGS. 2-9.

By centering one end of the pressure stabilizer tube 26 in the flow of the fluid from the storage reservoir 18, the pressure stabilizer tube 26 introduces a pressure measurement point at or near the center of the flow of the fluid. Thus, the pressure stabilizer tube 26 eliminates the velocity component to allow the hydrostatic pressure to be directly measured while the pump 22 provides the flow of the fluid from the storage reservoir 18.

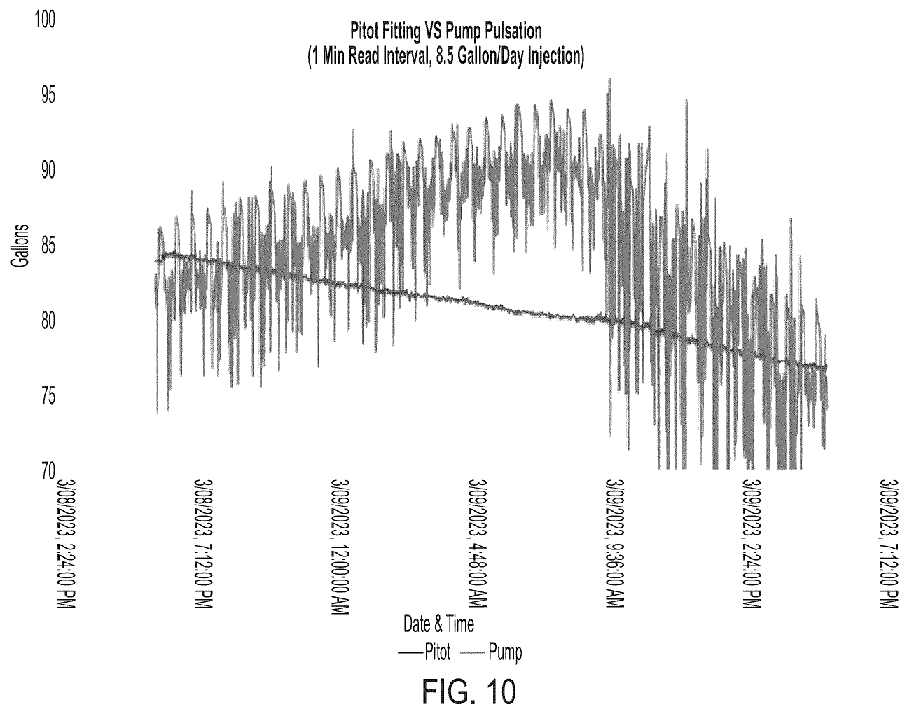

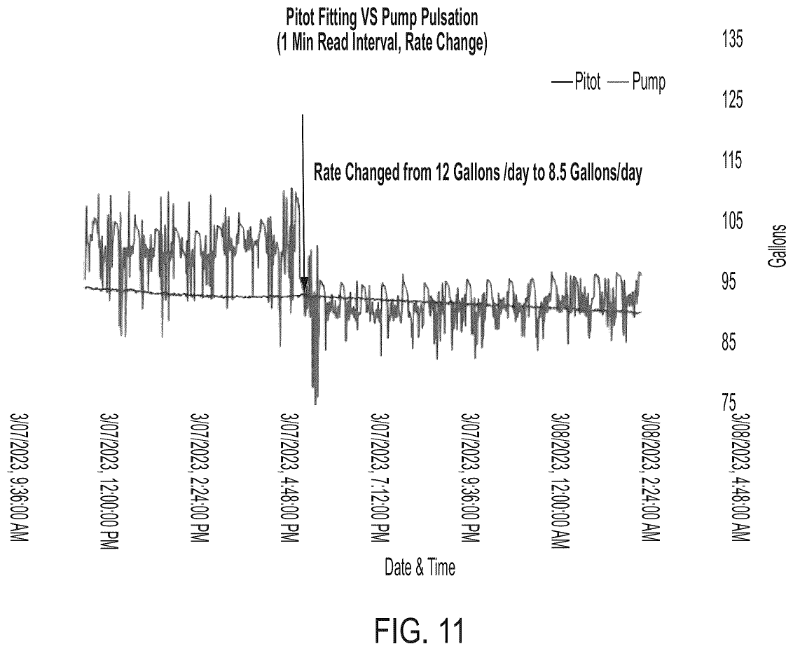

FIGS. 10 and 11 show a plot or graph of the tank level of the fluid in the storage reservoir 18 of the storage tank 12 over time measured by the pressure sensor 28 coupled to the pressure stabilizer tube 26 of the pump inlet pressure stabilizer 16 compared to the measurements of a control pressure sensor at the pump inlet piping. As shown in FIGS. 10 and 11, the control pressure sensor experiences pressure spikes, which causes the tank level measurement to vary over time. However, the pressure stabilizer tube 26 of the pump inlet pressure stabilizer 16 reduces the magnitude of the pressure spikes experienced by the sensor 28 so that the measured tank level may be more accurately measured as shown in FIGS. 10 and 11.

The pressure sensor 28 included in the system 10 is coupled to the other end of the pressure stabilizer tube 26 as suggested in FIGS. 1-9. The pressure sensor 28 is coupled to the exterior tube section 42 of the pressure stabilizer tube 26. The pressure sensor 28 is configured to measure the hydrostatic pressure in the storage reservoir 18 to monitor the tank level of the fluid in the storage reservoir 18. The pressure sensor 28 is in fluid communication with the pressure-sensor fluid passageway 46.

The pressure sensor 28 may be coupled to a control unit 25 as suggested in FIG. 1. The control unit 25 may include a controller configured to receive the measurements from the sensor 28 and a processor configured to determine the tank level using the measurements received from the sensor 28. The control unit 25 may be coupled pump 22 to control the activation of the pump 22 to conduct a flow of the fluid from the storage reservoir 18 of the storage tank 12. The control unit 25 may be coupled to other sensor or components of the system 10.

In some embodiments, the sensor 28 may include the control unit having the controller and the processor to determine the tank level using the measurements. In some embodiments, the control unit 25 may include user interface or visual output that displays the tank level measurement for a user to view. In some embodiments, the sensor 28 may include a user interface or visual output to show/display the tank level measurement.

Turning again to the fluid system 10, the system 10 includes the storage tank 12, the pump system 14, and a tank-level monitoring system 15, which includes the pressure sensor 28 and the pump inlet pressure stabilizer 16 as shown in FIGS. 1-9. The storage tank 12 defines the storage reservoir 18. The pump system 14 is coupled to the storage tank 12 so as to selectively provide a flow of the fluid from the storage reservoir 18 of the storage tank 12. The tank-level monitoring system 15 is configured to monitor the tank level of the fluid in the storage tank 12.

The tank-level monitoring system 15 of the fluid system 10 includes the pressure sensor 28 and the pump inlet pressure stabilizer 16 as shown in FIG. 1. The pressure sensor 28 is configured to measure the hydrostatic pressure in the storage reservoir 18 to monitor the tank level of the fluid in the storage reservoir 18. The pump inlet pressure stabilizer 16 is coupled to a pipe 20 of the pump system 14 upstream of the pump 22. The pump inlet pressure stabilizer 16 is coupled to the pipe 20 and a pressure sensor 28 included in the system 10 to place the pressure sensor 28 in fluid communication with the storage reservoir 18 of the storage tank 12.

The pump system 14 includes the pipe 20 and the pump 22 as shown in FIG. 1. The pipe 20 is coupled to the storage tank 12. The pump 22 is in fluid communication with the storage reservoir 18 of the storage tank 12 through the pipe 20. The pump 22 is configured to selectively provide a flow of the fluid from the storage reservoir 18 of the storage tank 12 through the pipe 20.

The pipe 20 is comprised of multiple interconnecting pipe sections in illustrative embodiments. The pipe 20 includes a main pipe section 23 and a connecting pipe section 24 as shown in FIGS. 1-9. The connecting pipe section 24 is configured to extend between and interconnect the main pipe section 23. In some embodiments, the pipe 20 is one integral pipe section.

In illustrative embodiments, the exterior tube section 42 of the pressure stabilizer tube 26 extends from the interior tube section 40 through the connecting pipe section 24 away from the interior region 32 of the pipe 20.

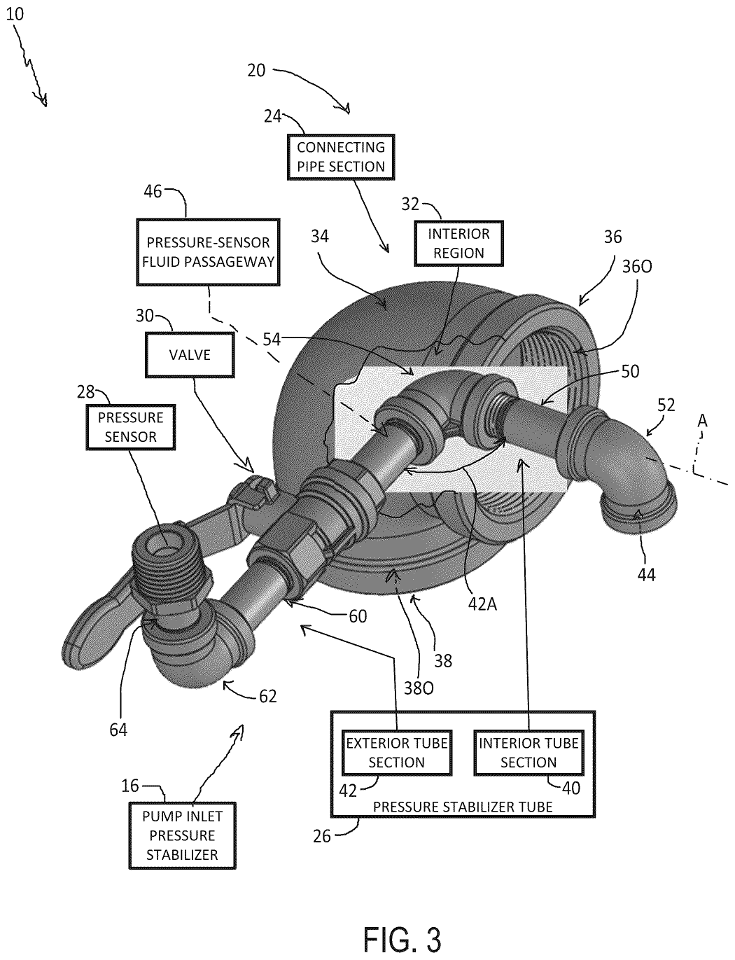

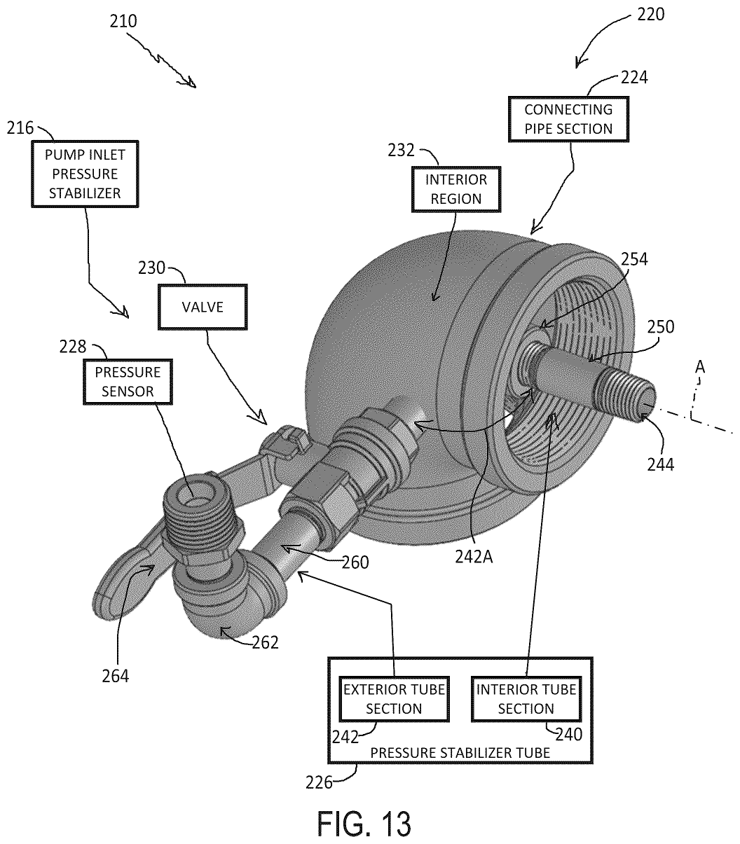

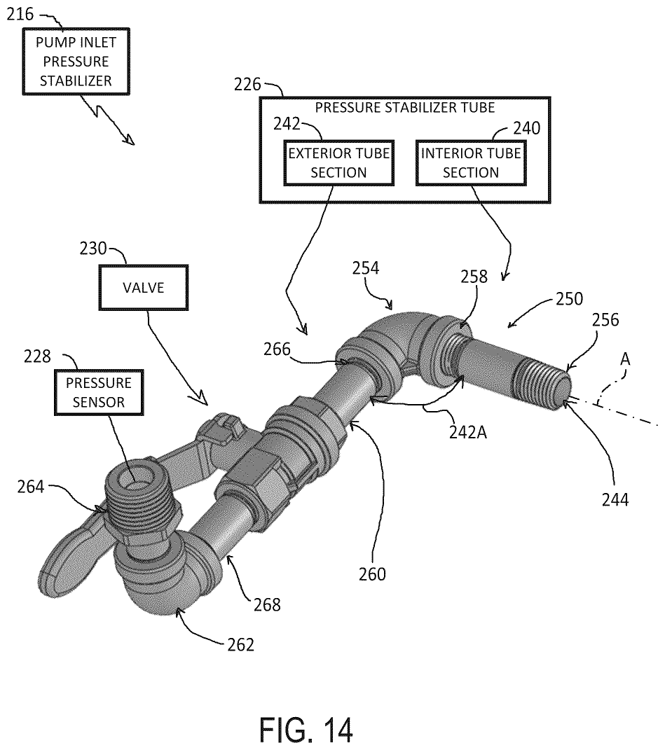

The connecting pipe section 24 has an outer wall 34 that extends between a first end 36 and a second end 38 as shown in FIGS. 2-6. The outer wall 34 extends circumferentially around an axis A. However, in illustrative embodiments, the connecting pipe section is not linear or straight like in FIGS. 13 and 14. Rather the connecting pipe section 24 has an elbow shape as shown in FIGS. 2 and 3.

The first and second ends 36, 38 of the connecting pipe section 24 are spaced apart from each other. Both ends 36, 38 are threaded in illustrative embodiments. Each end 36, 38 is configured to be threaded to the main pipe sections 23 of the pipe 20. In illustrative embodiments, the first and second ends 36, 38 define circular openings 36O, 38O.

The pump inlet pressure stabilizer 16 is coupled to the pipe 20 upstream of the pump 22 to be in fluid communication with the storage reservoir 18 of the storage tank 12 as shown in FIG. 1. In illustrative embodiments, the pump inlet pressure stabilizer 16 is coupled to the connecting pipe section 24 of the pipe 20 upstream of the pump 22. The pump inlet pressure stabilizer 16 includes the pressure stabilizer tube 26 in illustrative embodiments. The pressure sensor 28 included in the system 10 is coupled to the pressure stabilizer tube 26.

The pressure stabilizer tube 26 extends through the outer wall 34 of the connecting pipe section 24 of the pipe 20 as shown in FIGS. 2 and 3. In illustrative embodiments, a portion of the interior tube section 40 of the pressure stabilizer tube 26 is concentric with one of the openings 36O, 38O of the connecting pipe section 24 and the main pipe section of the pipe 20 so that the opening 44 is located near the center of the flow of the fluid through the connecting pipe section 24. In illustrative embodiments, the center of the flow of the fluid is located at the axis A.

In illustrative embodiments, the pressure stabilizer tube 26 may be integrally formed with the connecting pipe section 24. In this way, when the piping 20 of the pump system 14 is assembled, the pump inlet pressure stabilizer 16 is properly positioned in the interior region 32 by coupling the connecting pipe section 24 to the adjacent main pipe sections 23.

In some embodiments, the presser stabilizer tube 26 may be integrally formed with one of the main pipe sections 23. In some embodiments, the pressure stabilizer tube 26 is a separate piece inserted into a hole in the piping 20. A sealant or seals may be used to seal around the pressure stabilizer tube 26 and the pipe 20 in such embodiments.

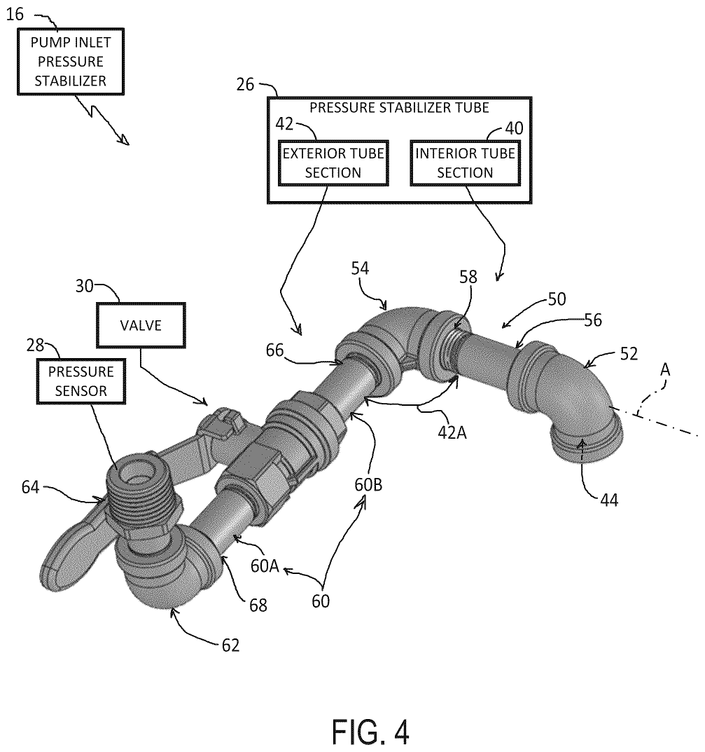

The pressure stabilizer tube 26 includes the interior tube section 40 and the exterior tube section 42 as shown in FIGS. 2-6. The interior tube section 40 defines the first section 46A of the pressure-sensor fluid passageway 46. The exterior tube section 42 defines the second section 46B of the pressure-sensor fluid passageway 46. The interior tube section 40 of the pressure stabilizer tube 26 is located in the interior region 32 of the pipe 20. The exterior tube section 42 of the pressure stabilizer tube 26 extends from the interior tube section 40 through the connecting pipe section 24 of the pipe 20 at the angle 43A relative to the interior tube section 40 as shown in FIGS. 2 and 4.

In illustrative embodiments, the angle 43A of the exterior tube section 42 of the pressure stabilizer tube 26 relative to the interior tube section 40 is about 90 degrees. The exterior tube section 42 is perpendicular to the interior tube section 40 as shown in FIG. 4.

In some embodiments, the angle 43A of the exterior tube section 42 of the pressure stabilizer tube 26 relative to the interior tube section 40 is between about 45 degrees and 135 degrees. In some embodiments, the angle 43A of the exterior tube section 40 of the pressure stabilizer tube 26 relative to the interior tube section 40 is between about 75 degrees and 125 degrees.

In some embodiments, the angle 43A of the exterior tube section 42 of the pressure stabilizer tube 26 relative to the interior tube section 40 is about 45 degrees. In some embodiments, the angle 43A of the exterior tube section 42 of the pressure stabilizer tube 26 relative to the interior tube section 40 is about 135 degrees.

The interior tube section 40 includes an interior straight member 50, a first interior elbow member 52, and a second interior elbow member 54 as shown in FIGS. 3-6. The interior straight member 50 extends linearly between a first end 56 and a second end 58. The interior straight member 50 is the portion of the interior tube section 40 that is concentric with the opening 36O of the connecting pipe section 24 and the main pipe section of the pipe 20 in illustrative embodiments.

The first interior elbow member 52, also referred to as the end interior elbow member 52, is configured to reduce the magnitude of the pressure spikes by isolating the hydrostatic pressure from the dynamic pressure. The variations in the dynamic pressure are not captured by the first interior elbow member 52. This way, the sensor 28 only measures the hydrostatic pressure, which is directly related to the fluid level in the tank 12. The first interior elbow member 52 may also help reduce debris from entering the pressure-sensor fluid passageway 46 of the pressure stabilizer tube 26.

The first interior elbow member 52 is coupled to the first end 56 of the interior straight member 50 as shown in FIG. 3. The second interior elbow member 54, also referred to as the linking interior elbow member 54, is coupled to the second end 58 of the interior straight member 50. The first interior elbow member 52 defines the opening 44 that is located near the center of the flow of the fluid from the storage reservoir 18.

The first interior elbow member 52 that defines the opening 44 is angled relative to the flow of the fluid from the tank 12. In illustrative embodiments, the opening 44 is perpendicular to the flow of the fluid from the tank 12. By offsetting the opening 44, the opening 44 is angled relative to the flow direction. Thus, the magnitude of the pressure spikes caused by the pump 22 is decreased since the pressure spikes are greater in the stream wise or flow direction.

In some embodiments, the first interior elbow member 52 is angled downwards or toward the ground so that the opening 44 faces downward. In some embodiments, the first interior elbow member 52 is angled upwards or away from the ground so that the opening 44 faces upward.

The first interior elbow member 52 is coupled to the first end 56 of the interior straight member 50 as shown in FIG. 3. The second interior elbow member 54, also referred to as the linking interior elbow member 54, is coupled to the second end 58 of the interior straight member 50. The first interior elbow member 52 defines the opening 44 that is located near the center of the flow of the fluid from the storage reservoir 18.

In illustrative embodiments, the interior straight member 50 is a pipe nipple 50 and the first and second elbow members 52, 54 are elbow fittings 52, 54 that are threadingly coupled to the opposing ends 56, 58 of the pipe nipple 50. In some embodiments, the interior tube section 40 is a single integral piece component rather than multiple components assembled together.

The exterior tube section 42 includes an exterior straight member 60, an exterior elbow member 62, and a sensor attachment member 64 as shown in FIGS. 3-6. The exterior straight member 60 extends linearly between a first end 66 and a second end 68. The first end 66 of the exterior straight member 60 is coupled to the second interior elbow member 54 so that the exterior straight member 60 extends at the angle 43A relative to the interior tube section 40. The exterior elbow member 62 is coupled to the second end 68 of the exterior straight member 60. The sensor attachment member 64 is coupled to exterior elbow member 62 so that the sensor attachment member 64 extends at an angle 64A relative to the exterior straight member 60.

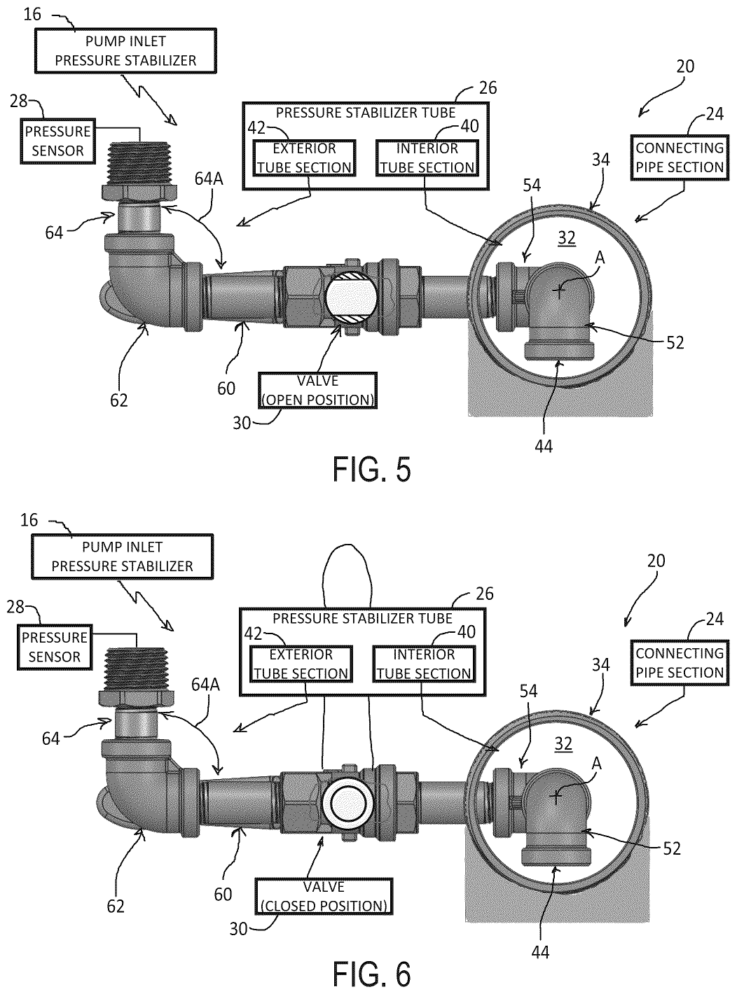

In illustrative embodiments, the angle 64A of the sensor attachment member 64 relative to the exterior straight member 60 is about 90 degrees. The sensor attachment member 64 is perpendicular to the exterior straight member 60 as shown in FIGS. 5 and 6.

In some embodiments, the angle 64A may be between about 45 degrees and 135 degrees. In some embodiments, the angle 64A may between about 75 degrees and 125 degrees. In some embodiments, the angle 64A may be about 45 degrees. In some embodiments, the angle 64A may be about 135 degrees.

In illustrative embodiments, the exterior straight member 60 is a pipe nipple 60 and the exterior elbow member 62 is an elbow fitting 62 that is threadingly coupled to the second end 68 of the exterior straight member 60. In some embodiments, the exterior tube section 42 is a single integral piece component rather than multiple components assembled together.

Each of the elbow fittings 52, 54, 62 are 90 degree elbows as shown in FIGS. 2-6. In some embodiments, the elbow fittings may be at an angle less than or greater than the 90 degrees. In some embodiments, the elbow fittings 52, 54, 62 have a U shape.

In illustrative embodiments, the pump inlet pressure stabilizer 16 further includes a valve 30 as shown in FIGS. 3-6. The ball valve 30 is coupled to the pressure stabilizer tube 26. In illustrative embodiments, the valve 30 is coupled to the exterior tube section 42 of the pressure stabilizer tube 26 as shown in FIGS. 3-6.

The valve 30 is configured to change between an open position as shown in FIG. 5 and a closed position as shown in FIG. 6. In the open position, the pressure sensor 28 is able to measure hydrostatic pressure in the storage reservoir 18. In the closed position, the pressure sensor 28 is isolated from the interior region 32 of the pipe 20.

In illustrative embodiments, the valve 30 is a ball valve 30 as shown in FIGS. 5 and 6. In some embodiments, the valve 30 may be another suitable valve to isolate the pressure sensor 28 when desired. In some embodiments, the valve 30 may be an automated valve and not a manual valve.

In illustrative embodiments, the exterior straight member 60 is two pieces 60A, 60B. The valve 30 is coupled between the two pieces 60A, 60B of the exterior straight member 60.

A method of operating the fluid system 10 may include several steps. The method may begin by conducting the flow of the fluid from the storage tank 12 through the pipe 20. The flow of the fluid is conducted through the pipe 20 by turning on the pump 22.

Next, the method includes measuring the hydrostatic pressure in the storage reservoir 18 of the storage tank 12 using the pressure sensor 28 while conducting the flow of the fluid from the storage tank 12 to monitor a tank level of the fluid in the storage reservoir 18. If measurements are no longer needed, the method may include moving the valve 30 to the closed position from the open position.

Another embodiment of a system 210 in accordance with the present disclosure is shown in FIGS. 13 and 14. The system 210 is substantially similar to the system 10 shown in FIGS. 1-9 and described herein. Accordingly, similar reference numbers in the 200 series indicate features that are common between the system 10 and the system 210. The description of the system 10 is incorporated by reference to apply to the system 210, except in instances when it conflicts with the specific description and the drawings of the system 210.

The system 210 includes a pump inlet pressure stabilizer 216 coupled to a pipe 220 and a pressure sensor 228 included in the system 210. The pump inlet pressure stabilizer 216 includes a pressure stabilizer tube 226 coupled to the presser sensor 228 as shown in FIGS. 13 and 14. The pressure stabilizer tube 226 is configured to reduce a magnitude of pressure spikes experienced by the pressure sensor 228 to allow the pressure sensor 228 to directly measure the hydrostatic pressure to determine the tank level.

The pressure stabilizer tube 226 defines a pressure-sensor fluid passageway 246 in fluid communication with the pipe 220 and the pressure sensor 228 as shown in FIGS. 13 and 14. The pressure stabilizer tube 226 includes an interior tube section 240 located in an interior region 232 of the pipe 220 and an exterior tube section 242 that extends from the interior tube section 240 through a connecting pipe section 224 of the pipe 220 away from the interior region 232 of the pipe 220. The interior tube section 240 of the pressure stabilizer tube 226 defines the first section 246A of the pressure-sensor fluid passageway 246 and the exterior tube section 242 of the pressure stabilizer tube 226 defines the second section 246B of the pressure-sensor fluid passageway 246.

The interior tube section 240 of the pressure stabilizer tube 226 defines an opening 244 located near a center of the flow of the fluid from the storage tank 12 as shown in FIGS. 13 and 14. The exterior tube section 242 extends from the interior tube section 240 at an angle 243A relative to the interior tube section 240.

Unlike the pressure stabilizer tube 26 of FIGS. 2-9, the interior tube section 240 does not include two interior elbow members. Rather, one end 256 of the interior straight member 250 is free of an elbow member. The other end 258 remains coupled to the interior elbow member 254. Therefore, the interior straight member 250 defines the opening 244 centered in the flow of the fluid.

The interior tube section 240 includes an interior straight member 250 and an interior elbow member 254 as shown in FIGS. 13 and 14. The interior straight member 250 extends linearly between a first end 256 and a second end 258.

The first end 256 of the interior straight member 250 is open to the interior region 232 of the pipe 220. The interior elbow member 254 is coupled to the second end 258 of the interior straight member 250. The first end 256 of the interior straight member 250 defines the opening 244 that is centered in the flow of the fluid.

In illustrative embodiments, the interior straight member 250 is a pipe nipple 250 and the interior elbow members 254 is an elbow fitting 254 that is threadingly coupled to the end 258 of the pipe nipple 250. In some embodiments, the interior tube section 240 is a single integral piece component rather than multiple components assembled together.

The exterior tube section 242 includes an exterior straight member 260, an exterior elbow member 262, and a sensor attachment member 264 as shown in FIG. 13. Similar to the exterior tube section 42 in FIGS. 2-9, the components of the exterior tube section 242 are the same.

In illustrative embodiments, the exterior straight member 260 is a pipe nipple 260 and the exterior elbow member 262 is an elbow fitting 262 that is threadingly coupled to the second end 268 of the exterior straight member 260. In some embodiments, the exterior tube section 242 is a single integral piece component rather than multiple components assembled together.

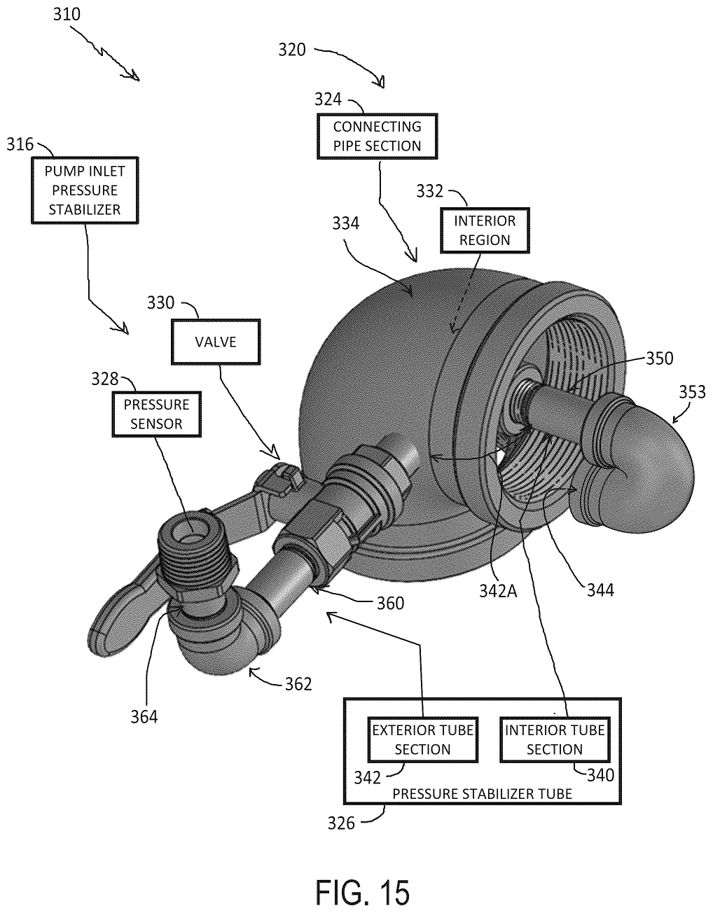

Another embodiment of a system 310 in accordance with the present disclosure is shown in FIG. 15. The system 310 is substantially similar to the system 10 shown in FIGS. 1-9 and described herein. Accordingly, similar reference numbers in the 300 series indicate features that are common between the system 10 and the system 310. The description of the system 10 is incorporated by reference to apply to the system 310, except in instances when it conflicts with the specific description and the drawings of the system 310.

The system 310 includes a pump inlet pressure stabilizer 316 coupled to a pipe 320 and a pressure sensor 228 included in the system 310. The pump inlet pressure stabilizer 316 includes a pressure stabilizer tube 326 coupled to the presser sensor 328 as shown in FIG. 15. The pressure stabilizer tube 326 is configured to reduce a magnitude of pressure spikes experienced by the pressure sensor 328 to allow the pressure sensor 328 to directly measure the hydrostatic pressure to determine the tank level.

The pressure stabilizer tube 326 defines a pressure-sensor fluid passageway 346 in fluid communication with the pipe 320 and the pressure sensor 328 as shown in FIG. 15. The pressure stabilizer tube 326 has an interior tube section 340 located in an interior region 332 of the pipe 320 and an exterior tube section 342 that extends from the interior tube section 340 through a connecting pipe section 324 of the pipe 320 away from the interior region 332 of the pipe 320. The interior tube section 340 of the pressure stabilizer tube 326 defines the first section 346A of the pressure-sensor fluid passageway 346 and the exterior tube section 342 of the pressure stabilizer tube 326 defines the second section 346B of the pressure-sensor fluid passageway 346.

The interior tube section 340 of the pressure stabilizer tube 326 defines an opening 344 located near a center of the flow of the fluid from the storage tank 12 as shown in FIG. 15. The exterior tube section 342 extends from the interior tube section 340 at an angle 343A relative to the interior tube section 340.

Unlike the pressure stabilizer tube 26 of FIGS. 2-9, the interior tube section 340 does not include two interior elbow members. Rather, the interior tube section 340 includes an interior u-member 353 instead of an elbow member. The interior u-member 353 bends 180 degrees so that the opening 344 defined by the interior u-member 353 faces opposite the flow of the fluid from the tank 12.

The exterior tube section 342 includes an exterior straight member 360, an exterior elbow member 362, and a sensor attachment member 364 as shown in FIG. 15. Similar to the exterior tube section 42 in FIGS. 3-6, the components of the exterior tube section 342 are the same.

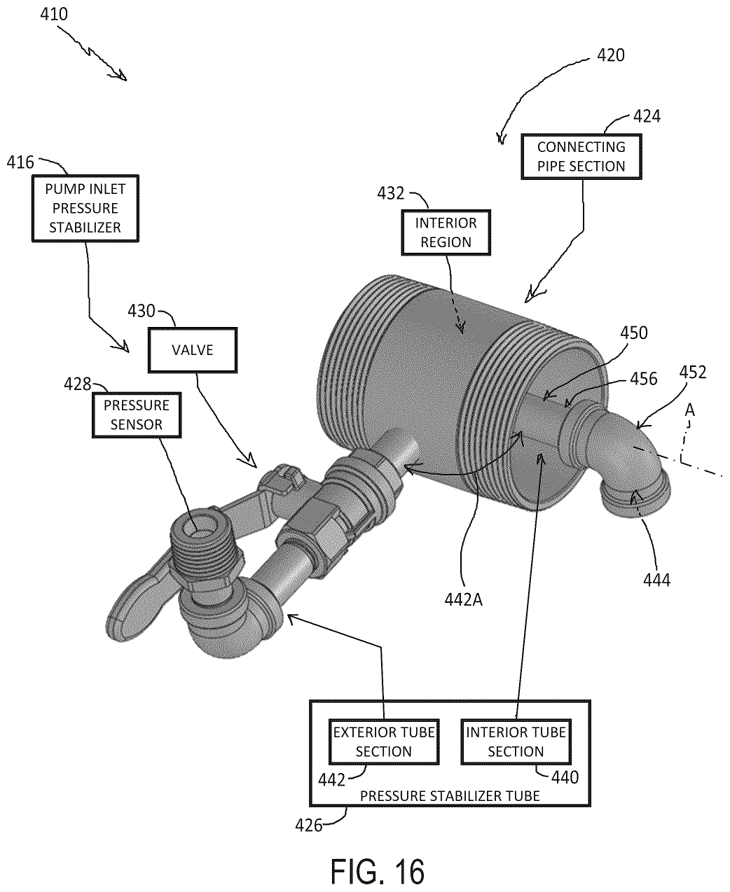

Another embodiment of a system 410 in accordance with the present disclosure is shown in FIG. 16. The system 410 is substantially similar to the system 10 shown in FIGS. 1-9 and described herein. Accordingly, similar reference numbers in the 400 series indicate features that are common between the system 10 and the system 410. The description of the system 10 is incorporated by reference to apply to the system 410, except in instances when it conflicts with the specific description and the drawings of the system 410.

The system 410 includes a pump inlet pressure stabilizer 416 coupled to a pipe 420 and a pressure sensor 428 included in the system 410. The pump inlet pressure stabilizer 416 includes a pressure stabilizer tube 426 coupled to the presser sensor 428 as shown in FIG. 16. The pressure stabilizer tube 426 is configured to reduce a magnitude of pressure spikes experienced by the pressure sensor 428 to allow the pressure sensor 428 to directly measure the hydrostatic pressure to determine the tank level.

The pressure stabilizer tube 426 defines a pressure-sensor fluid passageway 446 in fluid communication with the pipe 420 and the pressure sensor 428 as shown in FIG. 16. The pressure stabilizer tube 426 has an interior tube section 440 located in an interior region 432 of the pipe 420 and an exterior tube section 442 that extends from the interior tube section 440 through a connecting pipe section 424 of the pipe 420 away from the interior region 432 of pipe 420. The interior tube section 440 of the pressure stabilizer tube 426 defines the first section 446A of the pressure-sensor fluid passageway 446 and the exterior tube section 442 of the pressure stabilizer tube 426 defines the second section 446B of the pressure-sensor fluid passageway 446.

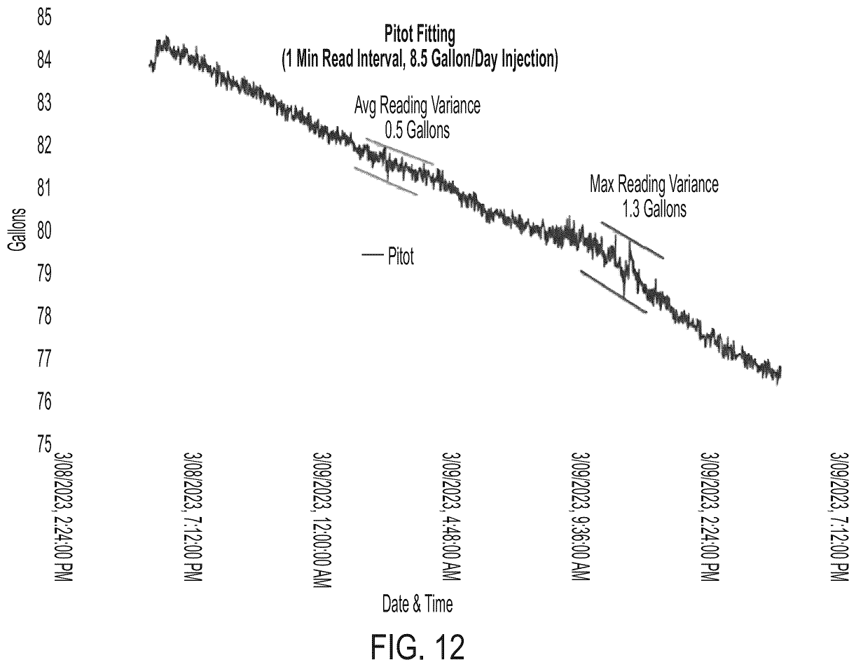

Unlike the connecting pipe sections 24, 224, 324 of FIGS. 2-15, the connecting pipe section 424 is straight as shown in FIG. 16. The connecting pipe section 424 extends around an axis A to define the interior region 432 of the pipe 420, also sometimes referred to as the main fluid passageway 432. The connecting pipe section 424 extends linearly between opposing ends.

In illustrative embodiments, the opposite ends have threads to couple the connecting pipe section 424 to the main pipe sections of the pipe 420. In some embodiments, the connecting pipe section 424 may be welded to the main pipe sections instead of having a thread connection.

The pressure stabilizer tube 426 includes an interior tube section 440 and an exterior tube section 442 as shown in FIG. 16. The interior tube section 440 of the pressure stabilizer tube 426 defines an opening 444 located near a center of the flow of the fluid from the storage tank 12 as shown in FIG. 16. The exterior tube section 442 extends from the interior tube section 440 at an angle 443A relative to the interior tube section 440.

The interior tube section 440 includes an interior straight member 450, a first interior elbow member 452, and a second interior elbow member (now shown) as shown in FIG. 16. The interior straight member 450 extends linearly between a first end 456 and a second end.

The first interior elbow member 452 coupled to the first end 456 of the interior straight member 450 is open to the interior region 432 of the pipe 420. The second interior elbow member is coupled to the second end of the interior straight member 450.

In some embodiments, the interior tube section 440 may instead include an interior u-member like in the embodiment of FIG. 15. The first interior elbow member 452 may be replaced with an interior u-member.

The exterior tube section 442 includes an exterior straight member 460, an exterior elbow member 462, and a sensor attachment member 464 as shown in FIG. 16. Similar to the exterior tube section 42 in FIGS. 4-6, the components of the exterior tube section 442 are the same.

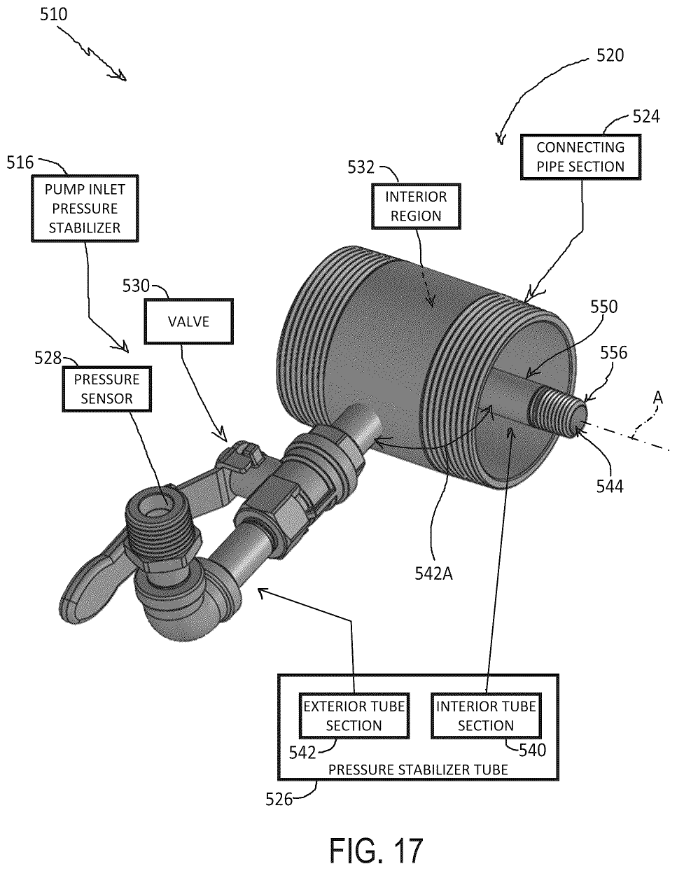

Another embodiment of a system 510 in accordance with the present disclosure is shown in FIG. 17. The system 510 is substantially similar to the system 10 shown in FIGS. 1-9 and described herein. Accordingly, similar reference numbers in the 500 series indicate features that are common between the system 10 and the system 510. The description of the system 10 is incorporated by reference to apply to the system 510, except in instances when it conflicts with the specific description and the drawings of the system 510.

The system 510 includes a pump inlet pressure stabilizer 516 coupled to a pipe 520 and a pressure sensor 528 included in the system 510. The pump inlet pressure stabilizer 516 includes a pressure stabilizer tube 526 and a pressure sensor 528 as shown in FIG. 17. The pressure stabilizer tube 526 is configured to reduce a magnitude of pressure spikes experienced by the pressure sensor 528 to allow the pressure sensor 528 to directly measure the hydrostatic pressure to determine the tank level.

The pressure stabilizer tube 526 defines a pressure-sensor fluid passageway 546 in fluid communication with the pipe 520 and the pressure sensor 528 as shown in FIG. 17. The pressure stabilizer tube 526 has an interior tube section 540 located in an interior region 532 of the pipe 520 and an exterior tube section 542 that extends from the interior tube section 540 through a connecting pipe section 524 of the pipe 520 away from the interior region 532 of the pipe 520. The interior tube section 540 of the pressure stabilizer tube 526 defines the first section 546A of the pressure-sensor fluid passageway 546 and the exterior tube section 542 of the pressure stabilizer tube 526 defines the second section 546B of the pressure-sensor fluid passageway 546.

Unlike the pressure stabilizer tube 426 of FIG. 16, the interior tube section 540 does not include two interior elbow members. Rather, one end 556 of the interior straight member 550 is free of an elbow member. The other end remains coupled to the corresponding interior elbow member. Therefore, the interior straight member 550 defines the opening 544 centered in the flow of the fluid. Additionally, the connecting pipe section 524 is straight and does not have an elbow shape like the connecting pipe sections 24, 224, 324 of FIGS. 2-15.

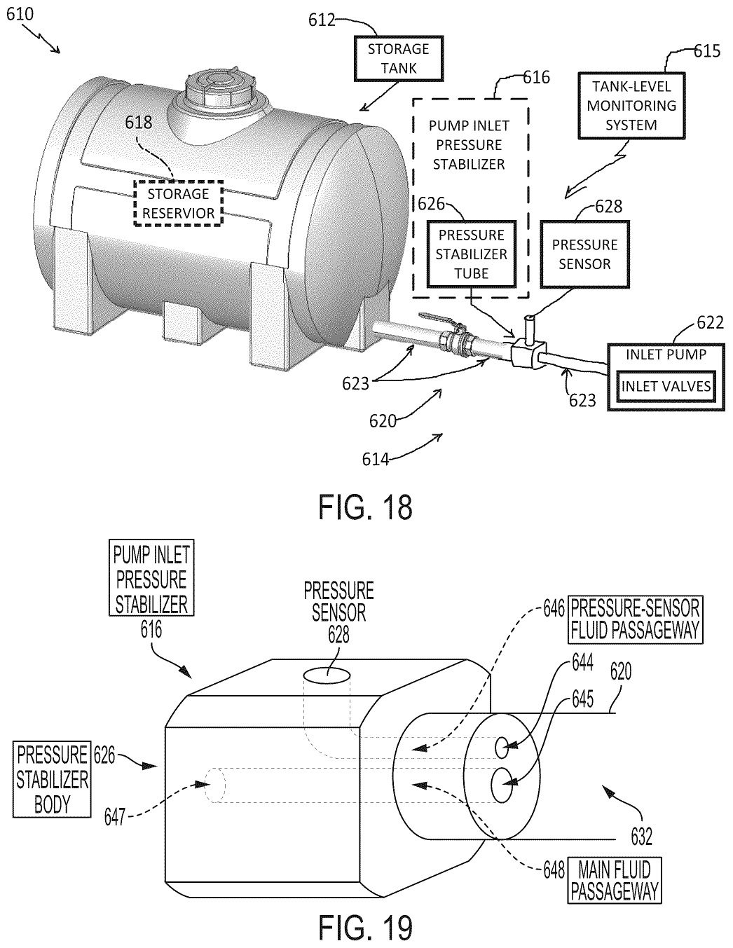

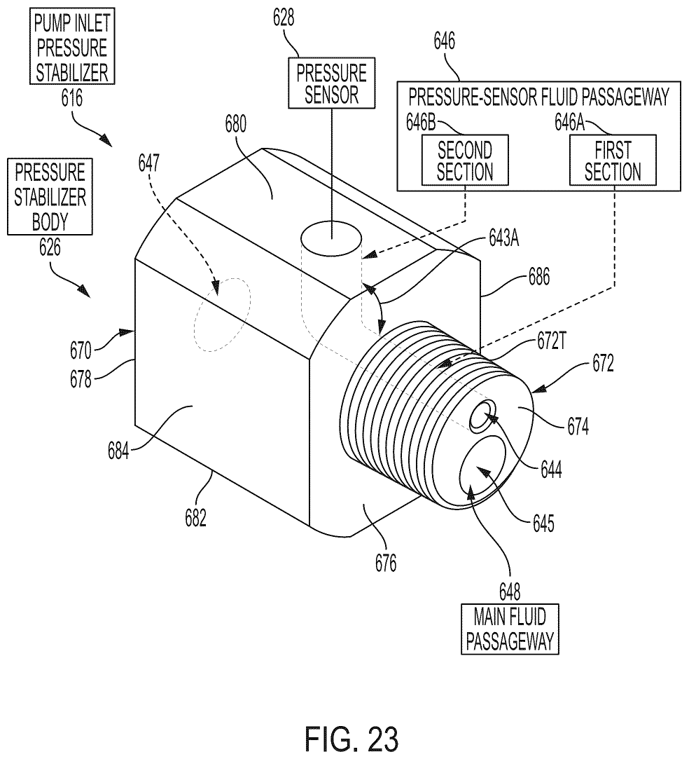

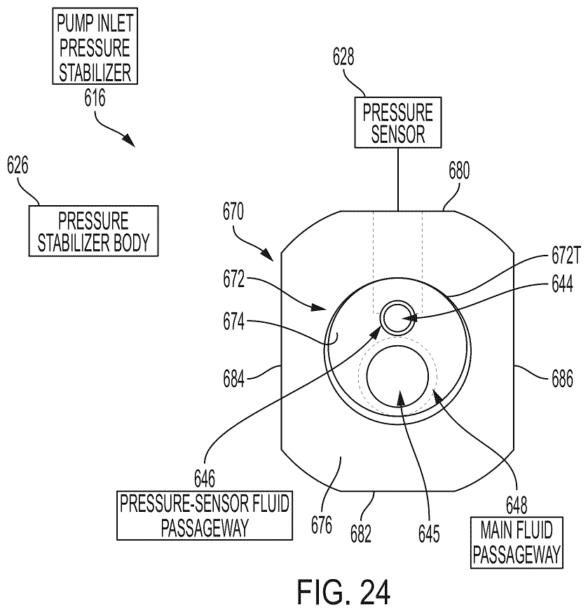

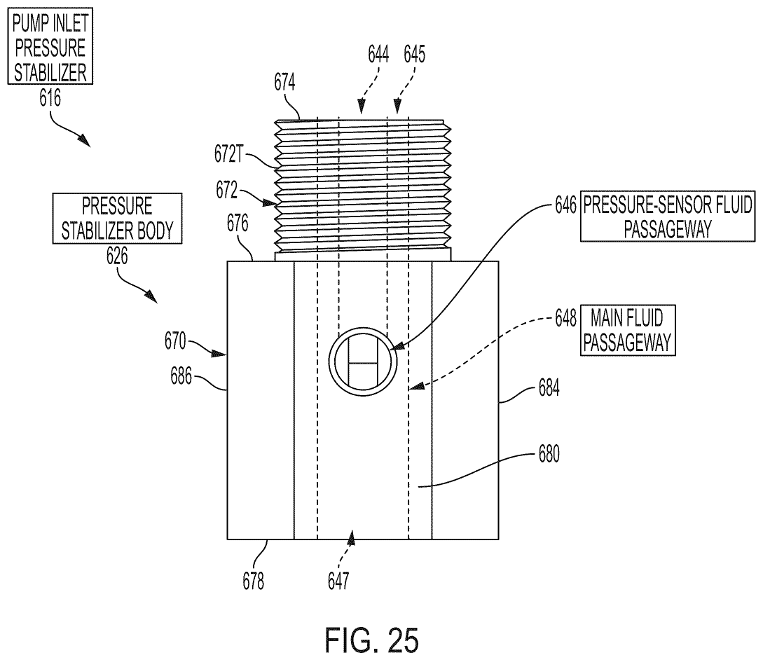

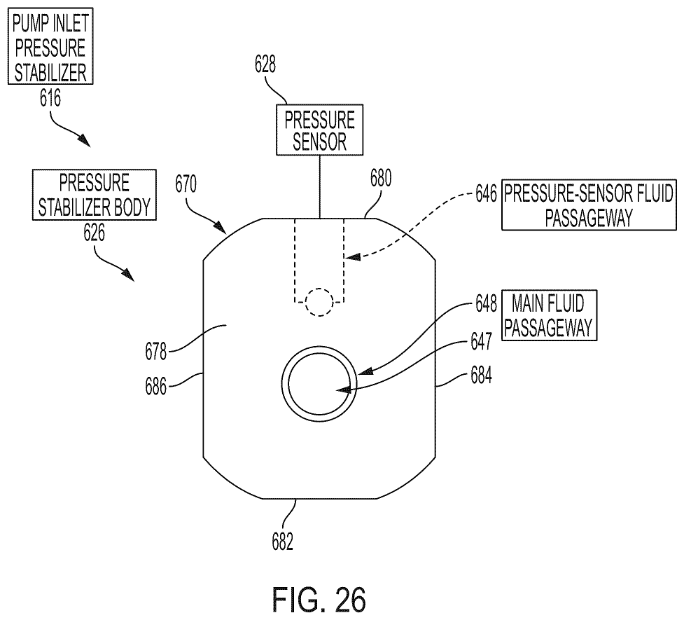

Another embodiment of a system 610 in accordance with the present disclosure is shown in FIG. 18-26. The system 610 is substantially similar to the system 10 shown in FIGS. 1-9 and described herein. Accordingly, similar reference numbers in the 600 series indicate features that are common between the system 10 and the system 610. The description of the system 10 is incorporated by reference to apply to the system 610, except in instances when it conflicts with the specific description and the drawings of the system 610.

The fluid system 610 includes a storage tank 612, a pump system 614, and a pump inlet pressure stabilizer 616 as shown in FIGS. 18-26. The storage tank 612 is formed to define a storage reservoir 618 configured to store a supply or an amount of a fluid. The pump system 614 is coupled to the storage tank 612 so as to selectively provide a flow of the fluid from the storage reservoir 18 of the storage tank 612. The pump inlet pressure stabilizer 616 is coupled to a pipe 620 of the pump system 614 upstream of the pump 622. The pump inlet pressure stabilizer 616 is also coupled to a pressure sensor 628 included in the system 610. The pump inlet pressure stabilizer 16 is coupled to the pipe 620 and the pressure sensor 628 to place the pressure sensor 628 in fluid communication with the storage reservoir 618 of the storage tank 612.

The pump inlet pressure stabilizer 616 is configured to allow direct measurement of the hydrostatic pressure in the storage reservoir 618 of the storage tank 612 while the fluid flows from the storage reservoir 618. The pump inlet pressure stabilizer 616 allows for direct measurement of the hydrostatic pressure in the storage reservoir 618 by reducing pressure pulsations or spikes in the pipe 620.

The pump inlet pressure stabilizer 616 is configured to reduce a magnitude of pressure spikes from the pump 622 experienced by the pressure sensor 628 to allow the pressure sensor 628 to directly measure the hydrostatic pressure to determine a tank level of the fluid in the storage reservoir 618 while the fluid flows from the storage reservoir 618. The pump inlet pressure stabilizer 616 reduces the magnitude of the pressure spikes by isolating the hydrostatic pressure from the dynamic pressure. The variations in the dynamic pressure are not captured by the pump inlet pressure stabilizer 616. This way, the sensor 628 only measures the hydrostatic pressure, which is directly related to the fluid level in the tank 612 so that the tank level of the fluid in the storage reservoir 618 of the storage tank 612 may be monitored while the fluid flows from the storage reservoir 618.

Measurement of liquid levels in storage tanks 612, specifically vented storage tanks, may be difficult due to the pressure pulsations or spikes by the pump system 614. In some embodiments, the inlet valves of the pump 622 may be quick closing valves. When these valves close quickly against a flowing liquid, it causes rapid velocity changes and pressure spikes.

The pump inlet pressure stabilizer 616 is configured to be coupled directly to the piping 620 of the pump system 614 to allow for direct pressure measurement at or near a center of the flow from the storage reservoir 618 of the storage tank 612. The pump inlet pressure stabilizer 616 eliminates the velocity component of the pressure which causes the pressure spikes in the pipe 620. This allows for a simple pressure sensor 628 without the use of any additional automation or modification to the storage tank 612.

The pump inlet pressure stabilizer 616 includes a pressure stabilizer body 626 as shown in FIGS. 18-26. The pressure stabilizer body 626 defines a pressure-sensor fluid passageway 646 and a main fluid passageway 648. The pressure-sensor fluid passageway 646 is in fluid communication with the pressure sensor 628 included in the system 610. The main fluid passageway 648 is in fluid communication with the pipe 620 to allow the flow of the fluid from the storage reservoir 618 to flow through the pump inlet pressure stabilizer 616. The main fluid passageway 648 has an inlet 645 and an outlet 647 as shown in FIGS. 19-26.

The pressure-sensor fluid passageway 646 has a first section 646A that extends axially into the pressure stabilizer body 626 relative to an axis A and a second section 646B that extends from the first section 646A at an angle 643A relative to the first section 646A as shown in FIGS. 18-26. The first section 646A of the pressure-sensor fluid passageway 646 defined by the pressure stabilizer body 626 has an inlet opening 644 located near a center of the flow of the fluid from the storage tank 612 as shown in FIGS. 18-26. The inlet opening 644 is located at or near the center of the flow of the fluid to allow the pressure sensor 628 to directly measure the hydrostatic pressure while the fluid flows from the storage reservoir 618 of the storage tank 612.

By locating the pressure-sensor fluid passageway 646 near the center of the flow of the fluid from the storage reservoir 618, the pressure stabilizer body 626 introduces a pressure measurement point near the center of the flow of the fluid. Thus, the pressure stabilizer body 626 eliminates the velocity component to allow the hydrostatic pressure to be directly measured while the pump 622 provides the flow of the fluid from the storage reservoir 618.

The pressure sensor 628 included in the system 610 is coupled to the pressure stabilizer body 626 at the other end of the pressure-sensor fluid passageway 646 as suggested in FIGS. 18-26. The pressure sensor 628 is coupled to the pressure stabilizer body 626. The pressure sensor 628 is configured to measure the hydrostatic pressure in the storage reservoir 618 to monitor the tank level of the fluid in the storage reservoir 618. The pressure sensor 628 is in fluid communication with the pressure-sensor fluid passageway 646.

Turning again to the fluid system 610, the system 610 includes the storage tank 612, the pump system 614, and a tank-level monitoring system 615, which includes the pressure sensor 628 and the pump inlet pressure 616 as shown in FIGS. 18-26. The storage tank 612 defines the storage reservoir 618. The pump system 614 is coupled to the storage tank 612 so as to selectively provide a flow of the fluid from the storage reservoir 618 of the storage tank 612. The pressure sensor 628 is configured to measure the hydrostatic pressure in the storage reservoir 618 to monitor the tank level of the fluid in the storage reservoir 618. The pump inlet pressure stabilizer 616 is coupled to the pipe 620 and a pressure sensor 628 to place the pressure sensor 628 in fluid communication with the storage reservoir 618 of the storage tank 612.

The pump system 614 includes the pipe 620 and the pump 622 as shown in FIG. 18. The pipe 620 is coupled to the storage tank 612. The pump 622 is in fluid communication with the storage reservoir 618 of the storage tank 612 through the pipe 620. The pump 622 is configured to selectively provide a flow of the fluid from the storage reservoir 618 of the storage tank 612 through the pipe 620.

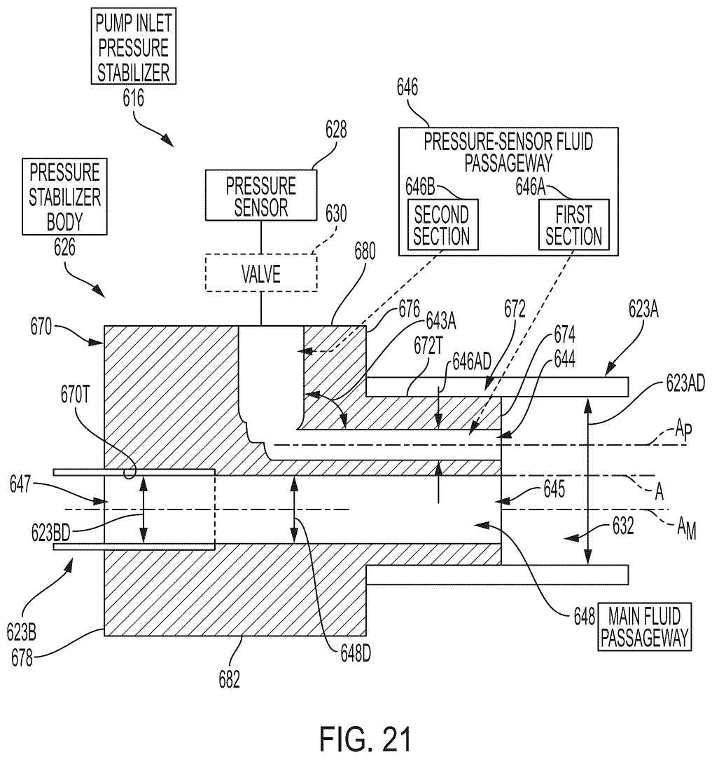

The pipe 620 is comprised of multiple interconnecting pipe sections 623 in illustrative embodiments. The pump inlet pressure stabilizer 616 is coupled between two pipe section 623 as shown in FIGS. 18 and 21. The pump inlet pressure stabilizer 616 is configured to extend between and interconnect the pipe sections 623.

The pump inlet pressure stabilizer 616 is coupled to the pipe 620 upstream of the pump 622 to be in fluid communication with the storage reservoir 618 of the storage tank 612 as shown in FIG. 18. In illustrative embodiments, the pump inlet pressure stabilizer 616 is coupled to the connecting pipe section 624 of the pipe 620 upstream of the pump 622. The pump inlet pressure stabilizer 616 includes the pressure stabilizer body 626 in illustrative embodiments. The pressure sensor 628 included in the system 610 is coupled to the pressure stabilizer body 626.

The pump inlet pressure stabilizer 616 includes a pressure stabilizer body 626 that is formed to define the pressure-sensor fluid passageway 646 and the main fluid passageway 648 as shown in FIGS. 19-26. The pressure-sensor fluid passageway 646 has the first section 646A that extends axially into the pressure stabilizer body 626 relative to the axis A and the second section 646B that extends from the first section 646A at an angle 643A relative to the first section 646A as shown in FIGS. 19-23.

The first section 646A of the pressure-sensor fluid passageway 646 defined by the pressure stabilizer body 626 has the inlet opening 644 located near a center of the flow of the fluid from the storage tank 612 as shown in FIGS. 19-23. The inlet opening 644 is located at or near the center of the flow of the fluid to allow the pressure sensor 628 to directly measure the hydrostatic pressure while the fluid flows from the storage reservoir 618 of the storage tank 612.

The pressure stabilizer body 626 includes a main section 670 and a connecting section 672 as shown in FIGS. 19-26. The main section 670 extends between a first end 676 and a second end 678 spaced apart axially from the first end 676. The connecting section 672 extends axially from the first end 676 of the main section 670 to a terminal end 674. The terminal end 674 is spaced apart axially from the first end 676 of the main section 670.

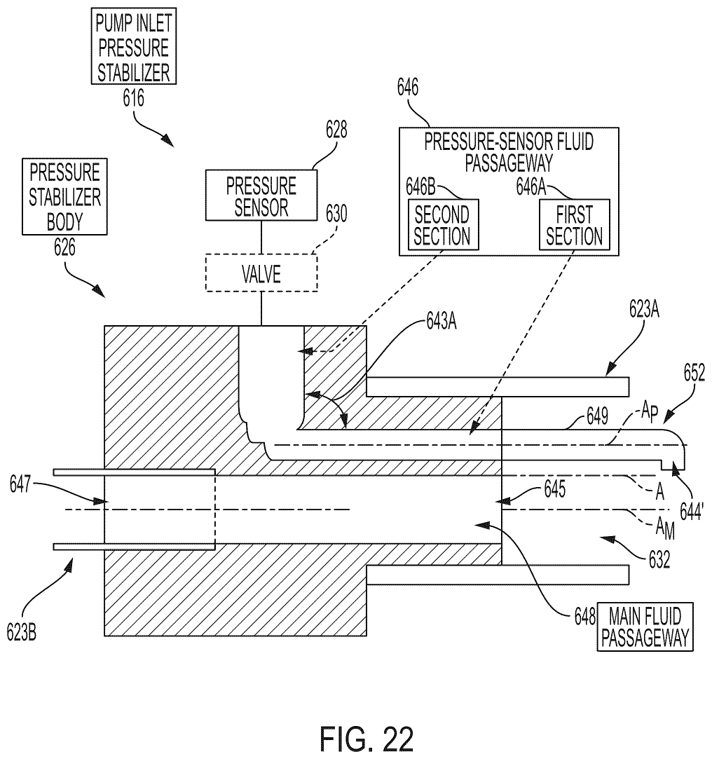

In illustrative embodiments, the pipe 620 has a first pipe section 623A coupled to an inlet end 674 of the pressure stabilizer body 626 and a second pipe section 623A coupled to an outlet end 678 of the pressure stabilizer body 626 spaced apart axially from the inlet end 674 of the pressure stabilizer body 626. In this way, the pressure stabilizer body 626 of the pump inlet pressure stabilizer 616 extends between and interconnects the first pipe section 623A and the second pipe section 623B. The first pipe section 623A is in fluid communication with the second pipe section 623B through the main fluid passageway 648 as shown in FIGS. 21 and 22.

In illustrative embodiments, the first pipe section 623A extends over or screws onto the connecting section 672 of the pressure stabilizer body 626 as suggested in FIG. 21. The second pipe section 623B fits into the main passageway 648 at the outlet end 678 of the pressure stabilizer body 626 as suggested in FIG. 21. In some embodiments, the pipe sections 623A, 623B may couple to the pressure stabilizer body 626 another way.

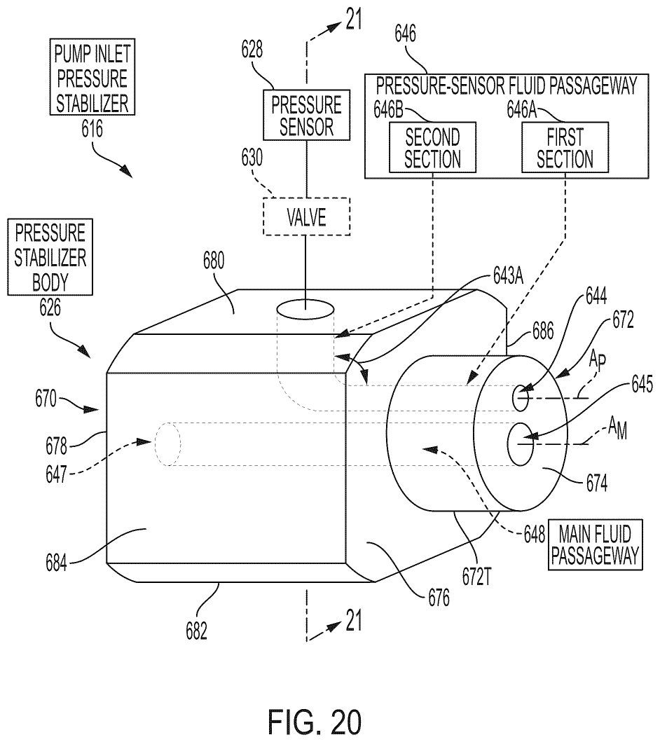

The main section 670 includes outer surfaces 680, 682, 684, 686 that extend axially between the first and second ends 676, 678 of the main section 670 as shown in FIGS. 20 and 21. The main section 670 has a cuboid shape in illustrative embodiments. In some embodiments, the main section 670 has a cylindrical shape. In some embodiments, the main section 670 may have another suitable shape.

The connecting section 672 has a cylindrical shape in illustrative embodiments. The connecting section 672 has an outer surface that extends circumferentially around the axis A. The outer surface is formed to include threads 672T that mate with threads formed in the pipe section 623A as shown in FIG. 20-23. In the illustrative embodiment, a portion of the main fluid passageway 648, or the outlet 647, may have threads 670T that mate with threads formed in the pipe section 623B as shown in FIG. 20-23.

The first section 646A of the pressure-sensor fluid passageway 646 extends through the connecting section 672 of the pressure stabilizer body 626 into the main section 670. The second section 646B of the pressure-sensor fluid passageway 646 extends from the first section 646A through the main section 670. The main fluid passageway 648 extends axially through the connecting section 672 and the main section 670 from the terminal end 674 of the connecting section 672 to the second end 678 of the main section 670.

The inlet opening 644 to the first section 646A of the pressure-sensor fluid passageway 646 is offset from the center of the flow of the fluid from the storage tank 612. The first section 646A of the pressure-sensor fluid passageway 646 extends along axis A_{P} which is parallel to axis A. The main fluid passageway 648 extends along axis A_{M}, which is parallel to the axis A. In illustrative embodiments, the first section 646A of the pressure-sensor fluid passageway 646 is radially offset from the main fluid passageway 648. In other words, the axis A_{M} of the main fluid passageway 648 is spaced apart radially from the axis A_{P} of the pressure-sensor fluid passageway 646 relative to the axis A as shown in FIGS. 20-22.

In illustrative embodiments, the first section 646A of the pressure-sensor fluid passageway 646 has a first diameter 646AD and the main fluid passageway 648 has a second diameter 648D that is greater than the first diameter 648AD of the pressure-sensor fluid passageway 646. In illustrative embodiments, the first pipe section 623A of the pipe 620 has a first inner diameter 623AD that is greater than the second diameter 648D of the main fluid passageway and the second pipe section 623B of the pipe 620 has a second inner diameter 623BD that is equal to second diameter 648D of the main fluid passageway 648 as shown in FIG. 21.

In some embodiments, like as shown in FIG. 22, the inlet pressure stabilizer 616 further includes an extension member 649 and an elbow member 652. The extension member 649 is coupled to the connecting section 672 of the pressure stabilizer body 626. The extension member 649 extends from the connecting section 672 of the pressure stabilizer body 626 away from the main section 670. The elbow member 652 is coupled to the other end of the extension member 649. The extension member 649 and the elbow member 652 each define a portion of the pressure-sensor fluid passageway 646. The elbow member 652 defines the inlet opening 644′ of the pressure-sensor fluid passageway 646 as shown in FIG. 22.

In some embodiments, the elbow member 652 may be directly coupled to the pressure stabilizer body 626. Like the first interior elbow member 52 in FIGS. 1-9, the elbow member 652 is configured to reduce the magnitude of the pressure spikes by isolating the hydrostatic pressure from the dynamic pressure. The variations in the dynamic pressure are not captured by the elbow member 652. This way, the sensor 628 only measures the hydrostatic pressure, which is directly related to the fluid level in the tank 612. The member 652 may also help reduce debris from entering the pressure-sensor fluid passageway 646 of the pressure stabilizer body 626.

In some embodiments, the inlet pressure stabilizer 616 may further include u-member, like the embodiment of FIG. 15, instead of an elbow member 652. The interior u-member bends 180 degrees so that the opening 644 defined by the interior u-member faces opposite the flow of the fluid from the tank 612.

Measurement of liquid levels in vented storage tanks may be difficult to achieve with a pressure measurement on the pump inlet piping. In typical systems, the pump's inlet valve(s) are quick closing valves. When a valve closes quickly against a flowing liquid, rapid velocity change occurs and a pressure spike may occur. The magnitude of the pressure spike may be a function of the liquid's mass, flow rate velocity and the rate of the change in velocity.

This phenomenon makes measurement of liquid level by pressure measurement unstable and unreliable because of the pressure spikes experienced from the pump strokes. To be able to measure the liquid level, the tank may need to be modified.

In some embodiments, the liquid level may be measured with a submersible pressure sensor, a pressure sensor directly attached to a port in the tank, or an ultrasonic measurement. In all cases, the tank may be modified with additional ports in the tank. In some cases, the tank may be retrofitted while the tank is in service.

When measurements are taken with a submersible sensor or ultrasonic sensor, the compatibility of the sensors must be tested for all liquids and vapors that may be generated in the tank. In other embodiments, the measurement may be taken by isolating the liquid level in a separate column and using PLC controllers to measure the level of the isolated column. The isolation of the liquid column may need multiple valve automation for measurement of the liquid level. This introduces cost to the measurement of liquid level.

The inlet pressure stabilizer 16, 216, 316, 416, 516, 616 allows for direct measurement of the hydrostatic pressure in the storage tank 12, 612 while the pump 22, 622 is pumping using a pressure sensor 28, 228, 328, 428, 528, 628 on the pump inlet piping 20, 620. The pressure stabilizer tube 26, 226, 326, 426, 526 or pressure stabilizer body 626 allows for the use of simple pressure sensors 28, 228, 328, 428, 528, 628 without any added valve automation.

The pump inlet pressure stabilizer 16, 216, 316, 416, 516, 616 may be a single piece device with a pressure stabilizer tube 26, 226, 326, 426, 526 or the pressure stabilizer body 626 placed in the direct flow of the fluid from the storage tank 12. The device 16, 216, 316, 416, 516, 616 introduces a pressure measurement in the middle of the flow, thus eliminating the velocity component of pressure that causes the pressure spikes in the pump inlet piping 20, 620.

The pump inlet pressure stabilizer 16, 216, 316, 416, 516 may be a quarter inch to two-inch diameter pipe section or pipe elbow with a pressure stabilizer tube 26, 226, 326, 426, 526 positioned at a 90-degree angle from the pipe wall 34 and centered in the flow. The pressure sample tube 26, 226, 326, 426, 526 is sixteenth inch to half inch diameter tube. Illustrative embodiments include a three-quarter inch diameter pipe section 24, 224, 324, 424, 524 with an eighth inch pressure sample tube 26, 226, 326, 426, 526. Attached to the sample tube 26, 226, 326, 426, 526 are fittings 64, 264 that allow for a pressure sensor 28, 228, 328, 428, 528 to be attached to the sample tube 26, 226, 326, 426, 526.

The pump inlet pressure stabilizer 616 includes a pressure stabilizer body 626 that is a single piece component made of plastic material. The pressure stabilizer body 626 may be formed using three-dimensional printing or manufacturing processes. The plastic material comprising the pressure stabilizer body 626 may include polyether ether ketone (PEEK), polytetrafluoroethylene (PTFE), polycarbonate, a phenolic component, acrylonitrile butadiene styrene (ABS), high density polyethylene (HDPE), a thermoplastic polymer, or any combination thereof.

The pump inlet pressure stabilizer 16, 216, 316, 416, 516, 616 may further include a valve 30, 230, 330, 430, 530, 630 for isolation of the pressure sensor 28, 228, 328, 428, 528, 628. Since the liquid being measured is incompressible, the pressure pulses are cascading through the system 10 until they enter the storage tank 12.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a device” is intended to include “at least one device” or “one or more devices.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any device or apparatus disclosed herein may comprise, consist of, or consist essentially of any element, component and/or feature disclosed herein or any combination of two or more of the elements, components or features disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A fluid system, comprising:
a storage tank formed to define a storage reservoir configured to store a fluid,
a pump system including a pipe coupled to the storage tank and a pump in fluid communication with the storage reservoir of the storage tank through the pipe and configured to selectively provide a flow of the fluid to and from the storage reservoir of the storage tank through the pipe,
a pressure sensor configured to measure a hydrostatic pressure in the storage reservoir to monitor a tank level of the fluid in the storage reservoir, and
a pump inlet pressure stabilizer coupled to the pipe and the pressure sensor to place the pressure sensor in fluid communication with the storage reservoir of the storage tank, the pump inlet pressure stabilizer configured to reduce a magnitude of pressure spikes from the pump experienced by the pressure sensor to allow the pressure sensor to directly measure the hydrostatic pressure to determine the tank level of the fluid in the storage reservoir while the fluid flows from the storage reservoir.

2. The fluid system of claim 1, wherein the pump inlet pressure stabilizer defines a pressure-sensor fluid passageway in fluid communication with the pressure sensor, the pressure-sensor fluid passageway having a first section that extends axially relative to an axis and a second section that extends from the first section at an angle relative to the first section, and wherein the first section of the pressure-sensor fluid passageway has an inlet opening located near a center of the flow of the fluid from the storage tank to allow the pressure sensor to directly measure the hydrostatic pressure while the fluid flows from the storage reservoir.

3. The fluid system of claim 2, wherein the angle of the first section of the pressure-sensor fluid passageway defined by the pump inlet pressure stabilizer relative to the second section of the pressure-sensor fluid passageway defined by the pump inlet pressure stabilizer is between about 45 degrees and about 135 degrees.

4. The fluid system of claim 3, wherein the angle of the first section of the pressure-sensor fluid passageway defined by the pump inlet pressure stabilizer relative to the second section of the pressure-sensor fluid passageway defined by the pump inlet pressure stabilizer is about 90 degrees.

5. The fluid system of claim 2, wherein the pump inlet pressure stabilizer includes a pressure stabilizer tube having an interior tube section located in an interior region defined by the pipe that is in fluid communication with the storage reservoir of the storage tank and an exterior tube section that extends from the interior tube section through the pipe away from the interior region of the pipe, wherein the interior tube section defines the first section of the pressure-sensor fluid passageway and the exterior tube section defines the second section of the pressure-sensor fluid passageway, and wherein the pressure sensor is coupled to the exterior tube section of the pressure stabilizer tube.

6. The fluid system of claim 5, wherein a portion of the interior tube section is concentric with the pipe.

7. The fluid system of claim 5, wherein the interior tube section of the pressure stabilizer tube includes an interior straight member that extends linearly between a first end and a second end, and a linking interior elbow member that extends between and interconnects the second end of the interior straight member and the exterior tube section.

8. The fluid system of claim 7, wherein the interior tube section of the pressure stabilizer tube further includes one of an end interior elbow member and an end interior u-member coupled to the first end of the interior straight member, wherein the end interior elbow member defines the opening so that the opening is perpendicular to the flow of the fluid from the storage reservoir, and wherein the end interior u-member defines the opening so that the opening faces opposite the flow of the fluid from the storage tank.

9. The fluid system of claim 5, wherein the exterior tube section of the pressure stabilizer tube includes an exterior straight member that extends linearly between a first end coupled to the interior tube section so that the exterior straight member extends at the angle relative to the interior tube section and a second end, an exterior elbow member coupled to the second end of the exterior straight member, and a sensor attachment member coupled to the exterior elbow member so that the sensor attachment member extends at a second angle relative to the exterior straight member.

10. The fluid system of claim 5, wherein the pipe includes a main pipe section and a connecting pipe section coupled to the main pipe section, wherein the exterior tube section extends from the interior tube section through the connecting pipe section away from the interior region of the pipe, and wherein the connecting pipe section has an elbow shape.

11. The fluid system of claim 2, wherein the pump inlet pressure stabilizer includes a pressure stabilizer body shaped to define the pressure-sensor fluid passageway and a main fluid passageway that extends axially through the pressure stabilizer body, wherein the first section of the pressure-sensor fluid passageway is spaced apart radially from the main fluid passageway.

12. The fluid system of claim 1, wherein the inlet opening to the first section of the pressure-sensor fluid passageway is offset from the center of the flow of the fluid from the storage tank.

13. The fluid system of claim 12, wherein the first section of the pressure-sensor fluid passageway has a first diameter and the main fluid passageway has a second diameter that is greater than the first diameter of the pressure-sensor fluid passageway.

14. The fluid system of claim 12, wherein the pipe has a first pipe section coupled to an inlet end of the pressure stabilizer body and a second pipe section coupled to an outlet end of the pressure stabilizer body spaced apart axially from the inlet end of the pressure stabilizer body so that the pressure stabilizer body of the pump inlet pressure stabilizer extends between and interconnects the first pipe section and the second pipe section, and wherein the first pipe section is in fluid communication with the second pipe section through the main fluid passageway.

15. The fluid system of claim 14, wherein the first pipe section of the pipe has a first inner diameter that is greater than a second diameter of the main fluid passageway and the second pipe section of the pipe has a second inner diameter that is equal to the second diameter of the main fluid passageway.

16. The fluid system of claim 1, wherein the pump inlet pressure stabilizer further includes a valve coupled to the pump inlet pressure stabilizer, the valve configured to change between an open position in which the pressure sensor is able to measure the hydrostatic pressure in the storage reservoir and a closed position in which the pressure sensor is isolated from the pipe.

17. A pump inlet pressure stabilizer adapted for use with a storage tank having a storage reservoir configured to store a supply of a fluid, the pump inlet pressure stabilizer comprising:
a pressure stabilizer body coupled to a pipe that is in fluid communication with the storage reservoir of the storage tank and a pressure sensor to place the pressure sensor in fluid communication with the storage reservoir of the storage tank, the pressure stabilizer body formed to define a pressure-sensor fluid passageway in fluid communication with the pressure sensor,
wherein the pressure-sensor fluid passageway has a first section that extends axially relative to an axis and a second section that extends from the first section at an angle relative to the first section, the first section of the pressure-sensor fluid passageway has an inlet opening located near a center of the flow of the fluid from the storage tank to reduce a magnitude of pressure spikes experienced by the pressure sensor as fluid flows from the storage reservoir to allow the pressure sensor to directly measure the hydrostatic pressure to determine a tank level of the fluid in the storage reservoir while the fluid flows from the storage reservoir.

18. The pump inlet pressure stabilizer of claim 17, wherein the angle of the first section of the pressure-sensor fluid passageway defined by the pump inlet pressure stabilizer relative to the second section of the pressure-sensor fluid passageway defined by the pump inlet pressure stabilizer is between about 45 degrees and about 135 degrees.

19. The pump inlet pressure stabilizer of claim 18, wherein the angle of the first section of the pressure-sensor fluid passageway defined by the pump inlet pressure stabilizer relative to the second section of the pressure-sensor fluid passageway defined by the pump inlet pressure stabilizer is about 90 degrees.

20. A method, comprising:
providing a storage tank formed to define a storage reservoir configured to store a supply of a fluid,
providing a pipe coupled to the storage tank that defines an interior region in fluid communication with the storage reservoir of the storage tank,
providing a pressure sensor configured to measure a hydrostatic pressure in the storage reservoir,
providing a pump inlet pressure stabilizer coupled to the pipe and the pressure sensor to place the pressure sensor in fluid communication with the storage reservoir of the storage tank, the pump inlet pressure stabilizer defining a pressure-sensor fluid passageway having a first section that extends axially relative to an axis and a second section that extends from the first section at an angle relative to the first section,
conducting a flow of the fluid from the storage tank through the pipe, and
measuring the hydrostatic pressure in the storage reservoir of the storage tank using the pressure sensor while conducting the flow of the fluid from the storage tank to monitor a tank level of the fluid in the storage reservoir,
wherein the first section of the pressure-sensor fluid passageway has an inlet opening located near a center of the flow of the fluid from the storage tank.
